(19) United States
(12) Patent Application Publication
(10) Pub. No.: US 2026/0019592 A1
(43) Pub. Date: Jan. 15, 2026

(54) LEARNED RESIDUAL CODING IN LATENT DOMAIN

(71) Applicant: Nokia Technologies Oy, Espoo (FI)

(72) Inventors: Francesco CRICRÌ, Tampere (FI); Honglei ZHANG, Tampere (FI); Nannan ZOU, Tampere (FI); Jukka Ilari AHONEN, Tampere (FI)

(21) Appl. No.: 19/261,288

(22) Filed: Jul. 7, 2025

Related U.S. Application Data
(60) Provisional application No. 63/669,774, filed on Jul. 11, 2024.

(51) Int. Cl. H04N 19/136; H04N 19/105; H04N 19/172

(52) U.S. Cl. CPC H04N 19/136; H04N 19/105; H04N 19/172

(57) ABSTRACT

An apparatus configured to: determine a first set of features based, at least partially, on an input data item using, at least, a first set of layers; determine a first latent tensor based, at least partially, on the first set of features using, at least, a second set of layers; encode the first latent tensor in a bitstream; determine residual information based, at least partially, on the first set of features and a second set of features associated with the input data item; determine a second latent tensor based, at least partially, on the residual information using, at least, a third set of layers; and encode the second latent tensor in the bitstream.

### TECHNICAL FIELD

The example and non-limiting embodiments relate generally to data encoding and decoding and, more particularly, to end-to-end learned coding.

### BACKGROUND

It is known, in image and video coding, to use neural networks to perform encoding and decoding functions as part of a codec.

### SUMMARY

The following summary is merely intended to be illustrative. The summary is not intended to limit the scope of the claims.

In accordance with one embodiment, an apparatus comprising: at least one processor; and at least one memory storing instructions that, when executed by the at least one processor, cause the apparatus at least to: determine a first set of features based, at least partially, on an input data item using, at least, a first set of layers; determine a first latent tensor based, at least partially, on the first set of features using, at least, a second set of layers; encode the first latent tensor in a first bitstream; decode the encoded first latent tensor from the first bitstream; determine a second set of features based, at least partially, on the decoded first latent tensor using, at least, a third set of layers; determine residual information based, at least partially, on the first set of features and the second set of features; determine a second latent tensor based, at least partially, on the residual information using, at least, a fifth set of layers; encode the second latent tensor in a second bitstream; decode the encoded second latent tensor from the second bitstream; determine decoded residual information based, at least partially, on the decoded second latent tensor using, at least, a sixth set of layers; and determine a decoded data item based, at least partially, on the second set of features and the decoded residual information using, at least, a fourth set of layers.

In accordance with one embodiment, a method comprising: determining, with a codec, a first set of features based, at least partially, on an input data item using, at least, a first set of layers; determining a first latent tensor based, at least partially, on the first set of features using, at least, a second set of layers; encoding the first latent tensor in a first bitstream; decoding the encoded first latent tensor from the first bitstream; determining a second set of features based, at least partially, on the decoded first latent tensor using, at least, a third set of layers; determining residual information based, at least partially, on the first set of features and the second set of features; determining a second latent tensor based, at least partially, on the residual information using, at least, a fifth set of layers; encoding the second latent tensor in a second bitstream; decoding the encoded second latent tensor from the second bitstream; determining decoded residual information based, at least partially, on the decoded second latent tensor using, at least, a sixth set of layers; and determining a decoded data item based, at least partially, on the second set of features and the decoded residual information using, at least, a fourth set of layers.

In accordance with one embodiment, an apparatus comprising means for: determining a first set of features based, at least partially, on an input data item using, at least, a first set of layers; determining a first latent tensor based, at least partially, on the first set of features using, at least, a second set of layers; encoding the first latent tensor in a first bitstream; decoding the encoded first latent tensor from the first bitstream; determining a second set of features based, at least partially, on the decoded first latent tensor using, at least, a third set of layers; determining residual information based, at least partially, on the first set of features and the second set of features; determining a second latent tensor based, at least partially, on the residual information using, at least, a fifth set of layers; encoding the second latent tensor in a second bitstream; decoding the encoded second latent tensor from the second bitstream; determining decoded residual information based, at least partially, on the decoded second latent tensor using, at least, a sixth set of layers; and determining a decoded data item based, at least partially, on the second set of features and the decoded residual information using, at least, a fourth set of layers.

In accordance with one embodiment, a computer-readable medium comprising program instructions stored thereon for performing at least the following: determining, with a codec, a first set of features based, at least partially, on an input data item using, at least, a first set of layers; determining a first latent tensor based, at least partially, on the first set of features using, at least, a second set of layers; encoding the first latent tensor in a first bitstream; decoding the encoded first latent tensor from the first bitstream; determining a second set of features based, at least partially, on the decoded first latent tensor using, at least, a third set of layers; determining residual information based, at least partially, on the first set of features and the second set of features; determining a second latent tensor based, at least partially, on the residual information using, at least, a fifth set of layers; encoding the second latent tensor in a second bitstream; decoding the encoded second latent tensor from the second bitstream; determining decoded residual information based, at least partially, on the decoded second latent tensor using, at least, a sixth set of layers; and determining a decoded data item based, at least partially, on the second set of features and the decoded residual information using, at least, a fourth set of layers.

In accordance with one embodiment, an apparatus comprising: at least one processor; and at least one memory storing instructions that, when executed by the at least one processor, cause the apparatus at least to: determine a first set of features based, at least partially, on an input data item using, at least, a first set of layers; determine a first latent tensor based, at least partially, on the first set of features using, at least, a second set of layers; encode the first latent tensor in a bitstream; determine residual information based, at least partially, on the first set of features and a second set of features associated with the input data item; determine a second latent tensor based, at least partially, on the residual information using, at least, a third set of layers; and encode the second latent tensor in the bitstream.

In accordance with one embodiment, a method comprising: determining, with an encoder, a first set of features based, at least partially, on an input data item using, at least, a first set of layers; determining a first latent tensor based, at least partially, on the first set of features using, at least, a second set of layers; encoding the first latent tensor in a bitstream; determining residual information based, at least partially, on the first set of features and a second set of features associated with the input data item; determining a second latent tensor based, at least partially, on the residual information using, at least, a third set of layers; and encoding the second latent tensor in the bitstream.

In accordance with one embodiment, an apparatus comprising means for: determining a first set of features based, at least partially, on an input data item using, at least, a first set of layers; determining a first latent tensor based, at least partially, on the first set of features using, at least, a second set of layers; encoding the first latent tensor in a bitstream; determining residual information based, at least partially, on the first set of features and a second set of features associated with the input data item; determining a second latent tensor based, at least partially, on the residual information using, at least, a third set of layers; and encoding the second latent tensor in the bitstream.

In accordance with one embodiment, a computer-readable medium comprising program instructions stored thereon for performing at least the following: determining, with an encoder, a first set of features based, at least partially, on an input data item using, at least, a first set of layers; determining a first latent tensor based, at least partially, on the first set of features using, at least, a second set of layers; encoding the first latent tensor in a bitstream; determining residual information based, at least partially, on the first set of features and a second set of features associated with the input data item; determining a second latent tensor based, at least partially, on the residual information using, at least, a third set of layers; and encoding the second latent tensor in the bitstream.

In accordance with one embodiment, an apparatus comprising: at least one processor; and at least one memory storing instructions that, when executed by the at least one processor, cause the apparatus at least to: decode an encoded first latent tensor, associated with an input data item, from a bitstream; determine a set of features based, at least partially, on the decoded first latent tensor using, at least, a first set of layers; decode an encoded second latent tensor from the bitstream; determine decoded residual information based, at least partially, on the decoded second latent tensor using, at least, a second set of layers; and determine a decoded data item based, at least partially, on the set of features and the decoded residual information using, at least, a third set of layers.

In accordance with one embodiment, a method comprising: decoding, with a decoder, an encoded first latent tensor, associated with an input data item, from a bitstream; determining a set of features based, at least partially, on the decoded first latent tensor using, at least, a first set of layers; decoding an encoded second latent tensor from the bitstream; determining decoded residual information based, at least partially, on the decoded second latent tensor using, at least, a second set of layers; and determining a decoded data item based, at least partially, on the set of features and the decoded residual information using, at least, a third set of layers.

In accordance with one embodiment, an apparatus comprising means for: decoding an encoded first latent tensor, associated with an input data item, from a bitstream; determining a set of features based, at least partially, on the decoded first latent tensor using, at least, a first set of layers; decoding an encoded second latent tensor from the bitstream; determining decoded residual information based, at least partially, on the decoded second latent tensor using, at least, a second set of layers; and determining a decoded data item based, at least partially, on the set of features and the decoded residual information using, at least, a third set of layers.

In accordance with one embodiment, a computer-readable medium comprising program instructions stored thereon for performing at least the following: decoding, with a decoder, an encoded first latent tensor, associated with an input data item, from a bitstream; determining a set of features based, at least partially, on the decoded first latent tensor using, at least, a first set of layers; decoding an encoded second latent tensor from the bitstream; determining decoded residual information based, at least partially, on the decoded second latent tensor using, at least, a second set of layers; and determining a decoded data item based, at least partially, on the set of features and the decoded residual information using, at least, a third set of layers.

According to some embodiments, there is provided the subject matter of the independent claims. Some further embodiments are defined in the dependent claims.

### BRIEF DESCRIPTION OF THE DRAWINGS

The foregoing embodiments and other features are explained in the following description, taken in connection with the accompanying drawings, wherein:

FIG. 1 is a block diagram of one possible and non-limiting example system in which the example embodiments may be practiced;

FIG. 2 is a block diagram of one possible and non-limiting exemplary system in which the example embodiments may be practiced;

FIG. 3 is a diagram illustrating features as described herein;

FIG. 4 is a diagram illustrating features as described herein;

FIG. 5 is a diagram illustrating features as described herein;

FIG. 6 is a diagram illustrating features as described herein;

FIG. 7 is a diagram illustrating features as described herein;

FIG. 8 is a diagram illustrating features as described herein;

FIG. 9 is a diagram illustrating features as described herein;

FIG. 10 is a diagram illustrating features as described herein;

FIG. 11 is a diagram illustrating features as described herein;

FIG. 12 is a diagram illustrating features as described herein;

FIG. 13 is a diagram illustrating features as described herein;

FIG. 14 is a diagram illustrating features as described herein;

FIG. 15 is a diagram illustrating features as described herein;

FIG. 16 is a flowchart illustrating steps as described herein;

FIG. 17 is a flowchart illustrating steps as described herein; and

FIG. 18 is a flowchart illustrating steps as described herein.

### DETAILED DESCRIPTION OF EMBODIMENTS

The following abbreviations that may be found in the specification and/or the drawing figures are defined as follows:
3GPP third generation partnership project
4G fourth generation
5G fifth generation
5GC 5G core network
APS adaptation parameter set
AR augmented reality
CABAC context-adaptive binary arithmetic coding
CDMA code division multiple access
CLVS coded layer video sequence
CPU central processing unit
CRAN cloud radio access network
DCT discrete cosine transform
E2E end-to-end
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FDMA frequency division multiple access
GAN generative adversarial network
gNB (or gNodeB) base station for 5G/NR, i.e., a node providing NR user plane and control plane protocol terminations towards the UE, and connected via the NG interface to the 5GC
GPU graphical processing unit
GSM global systems for mobile communications
HMD head-mounted display
IBC intra block copy
IEEE Institute of Electrical and Electronics Engineers
IMD integrated messaging device
IMS instant messaging service
IoT Internet of Things
JVET Joint Video Expert Team
LTE long term evolution
MAE mean absolute error
mAP mean average precision
MMS multimedia messaging service
MPEG-I Moving Picture Experts Group immersive codec family
MR mixed reality
MSE mean squared error
MS-SSIM multiscale structure similarity index measure
NAL network abstraction layer
ng or NG new generation
ng-eNB or NG-eNB new generation eNB
NN neural network
NNC neural network coding
NR new radio
N/W or NW network
O-RAN open radio access network
PC personal computer
PDA personal digital assistant
PSNR peak signal-to-noise ratio
QP quantization parameter
ROI region of interest
SEI supplemental enhancement information
SGD stochastic gradient descent
SMS short messaging service
SSIM structure similarity index measure
TCP-IP transmission control protocol-internet protocol
TDMA time division multiple access
UE user equipment (e.g., a wireless, typically mobile device)
UMTS universal mobile telecommunications system
USB universal serial bus
VCM video coding for machines
VMAF Video Multimethod Assessment Fusion
VNR virtualized network function
VR virtual reality
VVC volumetric video coding
WLAN wireless local area network

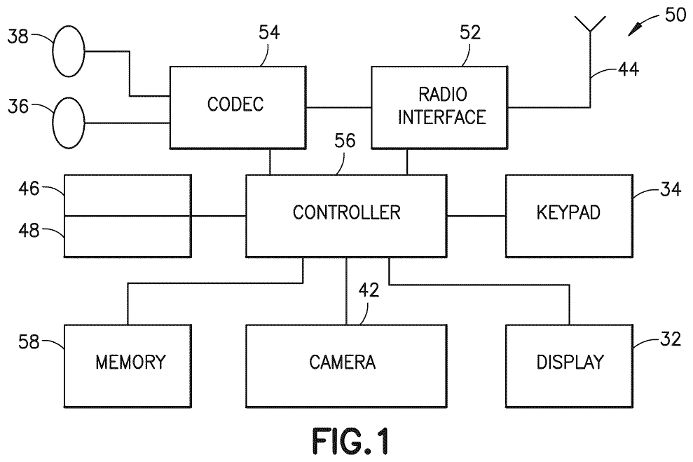

The following describes suitable apparatus and possible mechanisms for practicing example embodiments of the present disclosure. Accordingly, reference is first made to FIG. 1, which shows an example block diagram of an apparatus 50. The apparatus may be configured to perform various functions such as, for example, gathering information by one or more sensors, encoding and/or decoding information, receiving and/or transmitting information, analyzing information gathered or received by the apparatus, or the like. A device configured to encode a video scene may (optionally) comprise one or more microphones for capturing the scene and/or one or more sensors, such as cameras, for capturing information about the physical environment in which the scene is captured. Alternatively, a device configured to encode a video scene may be configured to receive information about an environment in which a scene is captured and/or a simulated environment. A device configured to decode and/or render the video scene may be configured to receive a Moving Picture Experts Group immersive codec family (MPEG-I) bitstream comprising the encoded video scene. A device configured to decode and/or render the video scene may comprise one or more speakers/audio transducers and/or displays, and/or may be configured to transmit a decoded scene or signals to a device comprising one or more speakers/audio transducers and/or displays. A device configured to decode and/or render the video scene may comprise a user equipment, a head/mounted display, or another device capable of rendering to a user an AR, VR and/or MR experience.

The electronic device 50 may for example be a mobile terminal or user equipment of a wireless communication system. Alternatively, the electronic device may be a computer or part of a computer that is not mobile. It should be appreciated that example embodiments of the present disclosure may be implemented within any electronic device or apparatus which may process data. The electronic device 50 may comprise a device that can access a network and/or cloud through a wired or wireless connection. The electronic device 50 may comprise one or more processors 56, one or more memories 58, and one or more transceivers 52 interconnected through one or more buses. The one or more processors 56 may comprise a central processing unit (CPU) and/or a graphical processing unit (GPU). Each of the one or more transceivers 52 includes a receiver and a transmitter. The one or more buses may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers may be connected to one or more antennas 44. The one or more memories 58 may include computer program code. The one or more memories 58 and the computer program code may be configured to, with the one or more processors 56, cause the electronic device 50 to perform one or more of the operations as described herein.

The electronic device 50 may connect to a node of a network. The network node may comprise one or more processors, one or more memories, and one or more transceivers interconnected through one or more buses. Each of the one or more transceivers includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers may be connected to one or more antennas. The one or more memories may include computer program code. The one or more memories and the computer program code may be configured to, with the one or more processors, cause the network node to perform one or more of the operations as described herein.

The electronic device 50 may comprise a microphone 36 or any suitable audio input which may be a digital or analogue signal input. The electronic device 50 may further comprise an audio output device 38 which in example embodiments of the present disclosure may be any one of: an earpiece, speaker, or an analogue audio or digital audio output connection. The electronic device 50 may also comprise a battery (or in other example embodiments of the present disclosure the device may be powered by any suitable mobile energy device such as solar cell, fuel cell, or clockwork generator). The electronic device 50 may further comprise a camera 42 or other sensor capable of recording or capturing images and/or video. Additionally or alternatively, the electronic device 50 may further comprise a depth sensor. The electronic device 50 may further comprise a display 32. The electronic device 50 may further comprise an infrared port for short range line of sight communication to other devices. In other example embodiments of the present disclosure the apparatus 50 may further comprise any suitable short-range communication solution such as for example a BLUETOOTH™ wireless connection or a USB/firewire wired connection.

It should be understood that an electronic device 50 configured to perform example embodiments of the present disclosure may have fewer and/or additional components, which may correspond to what processes the electronic device 50 is configured to perform. For example, an apparatus configured to encode a video might not comprise a speaker or audio transducer and may comprise a microphone, while an apparatus configured to render the decoded video might not comprise a microphone and may comprise a speaker or audio transducer.

Referring now to FIG. 1, the electronic device 50 may comprise a controller 56, processor or processor circuitry for controlling the apparatus 50. The controller 56 may be connected to memory 58 which in example embodiments of the present disclosure may store both data in the form of image and audio data and/or may also store instructions for implementation on the controller 56. The controller 56 may further be connected to codec circuitry 54 suitable for carrying out coding and/or decoding of audio and/or video data or assisting in coding and/or decoding carried out by the controller.

The electronic device 50 may further comprise a card reader 48 and a smart card 46, for example a UICC and UICC reader, for providing user information and being suitable for providing authentication information for authentication and authorization of the user/electronic device 50 at a network. The electronic device 50 may further comprise an input device 34, such as a keypad, one or more input buttons, or a touch screen input device, for providing information to the controller 56.

The electronic device 50 may comprise radio interface circuitry 52 connected to the controller and suitable for generating wireless communication signals for example for communication with a cellular communications network, a wireless communications system, or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The electronic device 50 may comprise a microphone 38, camera 42, and/or other sensors capable of recording or detecting audio signals, image/video signals, and/or other information about the local/virtual environment, which are then passed to the codec 54 or the controller 56 for processing. The electronic device 50 may receive the audio/image/video signals and/or information about the local/virtual environment for processing from another device prior to transmission and/or storage. The electronic device 50 may also receive either wirelessly or by a wired connection the audio/image/video signals and/or information about the local/virtual environment for encoding/decoding. The structural elements of electronic device 50 described above represent examples of means for performing a corresponding function.

The memory 58 may be of any type suitable to the local technical environment and may be implemented using any suitable data storage technology, such as semiconductor-based memory devices, flash memory, magnetic memory devices and systems, optical memory devices and systems, fixed memory and removable memory. The memory 58 may be a non-transitory memory. The memory 58 may be means for performing storage functions. The controller 56 may be or comprise one or more processors, which may be of any type suitable to the local technical environment, and may include one or more of general-purpose computers, special purpose computers, microprocessors, digital signal processors (DSPs) and processors based on a multi-core processor architecture, as non-limiting examples. The controller 56 may be means for performing functions.

The electronic device 50 may be configured to perform capture of a volumetric scene according to example embodiments of the present disclosure. For example, the electronic device 50 may comprise a camera 42 or other sensor capable of recording or capturing images and/or video. The electronic device 50 may also comprise one or more transceivers 52 to enable transmission of captured content for processing at another device. Such an electronic device 50 may or may not include all the modules illustrated in FIG. 1.

The electronic device 50 may be configured to perform processing of volumetric video content according to example embodiments of the present disclosure. For example, the electronic device 50 may comprise a controller 56 for processing images to produce volumetric video content, a controller 56 for processing volumetric video content to project 3D information into 2D information, patches, and auxiliary information, and/or a codec 54 for encoding 2D information, patches, and auxiliary information into a bitstream for transmission to another device with radio interface 52. Such an electronic device 50 may or may not include all the modules illustrated in FIG. 1.

The electronic device 50 may be configured to perform encoding or decoding of 2D information representative of volumetric video content according to example embodiments of the present disclosure. For example, the electronic device 50 may comprise a codec 54 for encoding or decoding 2D information representative of volumetric video content. Such an electronic device 50 may or may not include all the modules illustrated in FIG. 1.

The electronic device 50 may be configured to perform rendering of decoded 3D volumetric video according to example embodiments of the present disclosure. For example, the electronic device 50 may comprise a controller for projecting 2D information to reconstruct 3D volumetric video, and/or a display 32 for rendering decoded 3D volumetric video. Such an electronic device 50 may or may not include all the modules illustrated in FIG. 1.

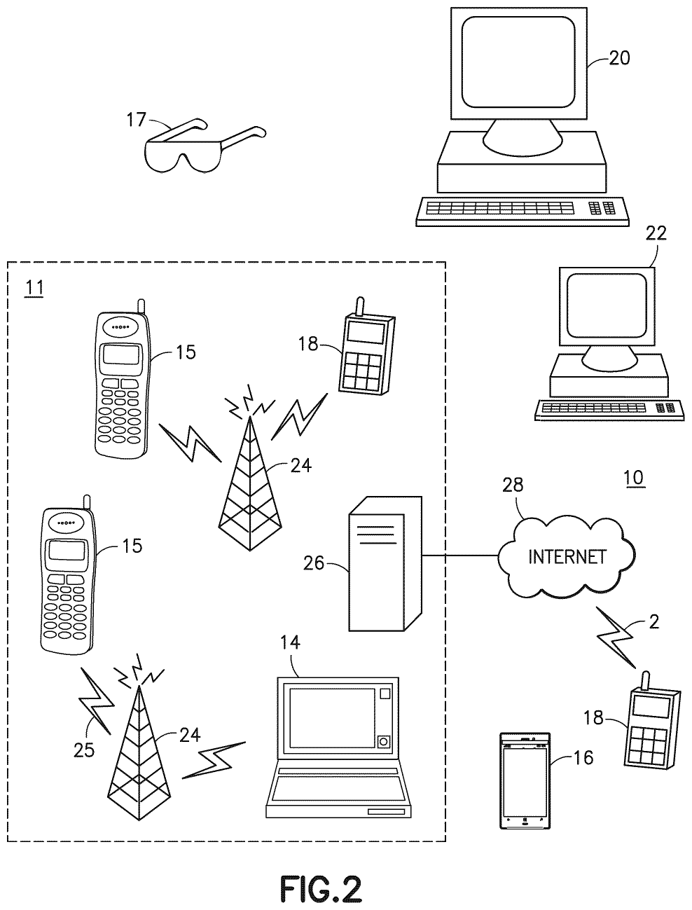

With respect to FIG. 2, an example of a system within which example embodiments of the present disclosure can be utilized is shown. The system 10 comprises multiple communication devices which can communicate through one or more networks. The system 10 may comprise any combination of wired or wireless networks including, but not limited to a wireless cellular telephone network (such as a GSM, UMTS, E-UTRA, LTE, CDMA, 4G, 5G, 6G network etc.), a wireless local area network (WLAN) such as defined by any of the IEEE 802.x standards, a BLUETOOTH™ personal area network, an Ethernet local area network, a token ring local area network, a wide area network, and/or the Internet. A wireless network may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors and memories, and also such virtualized entities create technical effects.

It may also be noted that operations of example embodiments of the present disclosure may be carried out by a plurality of cooperating devices (e.g. cRAN).

The system 10 may include both wired and wireless communication devices and/or electronic devices suitable for implementing example embodiments of the present disclosure.

For example, the system shown in FIG. 2 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an apparatus 15, a combination of a personal digital assistant (PDA) and a mobile telephone 14, a PDA 16, an integrated messaging device (IMD) 18, a desktop computer 20, a notebook computer 22, and a head-mounted display (HMD) 17. The electronic device 50 may comprise any of those example communication devices. In an example embodiment of the present disclosure, more than one of these devices, or a plurality of one or more of these devices, may perform the disclosed process(es). These devices may connect to the internet 28 through a wireless connection 2.

The example embodiments of the present disclosure may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding. The example embodiments of the present disclosure may also be implemented in cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Some or further apparatus may send and receive calls and messages and communicate with service providers through a wireless connection 25 to a base station 24, which may be, for example, an eNB, gNB, access point, access node, other node, etc. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), BLUETOOTH™, IEEE 802.11, 3GPP Narrowband IoT and any similar wireless communication technology. A communications device involved in implementing various example embodiments of the present disclosure may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, which may be a MPEG-I bitstream, from one or several senders (or transmitters) to one or several receivers.

Having thus introduced one suitable but non-limiting technical context for the practice of the example embodiments of the present disclosure, example embodiments will now be described with greater specificity.

### Fundamentals of Neural Networks

Features as described herein may generally relate to neural networks. A neural network (NN) may be described as a computation graph consisting of several layers of computation. In an example of a NN, each layer may consist of one or more units, where each unit may perform an elementary computation. A unit may be connected to one or more other units, and the connection may be associated with a weight. The weight may be used for scaling the signal passing through the associated connection. Weights are learnable parameters, i.e., values which can be learned from training data. There may be other learnable parameters, such as those of batch-normalization layers. Example embodiments of the present disclosure may or may not relate to, or involve, NN comprising multiple layers of computation.

In some neural networks, such as convolutional neural networks for image classification, initial layers (those close to the input data) may extract semantically low-level features such as edges and textures in images, whereas intermediate layers may extract higher-level features. After the feature extraction layers, there may be one or more layers performing a certain task, such as classification, semantic segmentation, object detection, denoising, style transfer, super-resolution, etc. Example embodiments of the present disclosure may or may not relate to, or involve, convolutional neural networks.

Neural networks are being utilized in an ever-increasing number of applications for many different types of devices, such as mobile phones. Examples include image and video analysis and processing, social media data analysis, device usage data analysis, etc.

One property of neural nets/networks (and other machine learning tools) is that they are able to learn properties from input data, e.g., in a supervised way or in an unsupervised way. Such learning may be a result of a training algorithm, or may be achieved by means of another neural network providing the training signal (sometimes, this latter approach may be referred to as “meta learning”).

In general, the training algorithm may consist of changing some properties of the neural network so that its output is as close as possible to a desired output. For example, in the case of classification of objects in images, the output of the neural network may be used to derive a class or category index which may indicate the class or category to which the object in the input image belongs. Training may comprise minimizing or decreasing the output's error, also referred to as the loss or loss function. Examples of losses are mean squared error, cross-entropy, etc. Example embodiments of the present disclosure may or may not relate to, or involve, neural networks trained according to a training algorithm.

In recent deep learning techniques, training may be an iterative process, where at each iteration the algorithm may modify the weights of the neural net to make a gradual improvement of the network's output, i.e., to gradually decrease the loss, for example by means of a gradient descent technique. In one example, at each training iteration, gradients of the loss function with respect to one or more weights or parameters of the NN may be computed, for example by a backpropagation technique; the computed gradients may then be used by an optimization routine, such as Adam or Stochastic Gradient Descent (SGD) to obtain an update to the one or more weights or parameters.

In the present disclosure, the terms “model”, “neural network”, “neural net” and “network” are used interchangeably. In the present disclosure, the weights of neural networks may sometimes be referred to as learnable parameters or simply as parameters.

Training a neural network may be regarded as an optimization process, but the final goal may be different from the typical goal of optimization. In optimization, the main goal is to minimize a function. In machine learning, the goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data is usually split into at least two sets, the training set and the validation set. The training set is used for training the network, i.e., to modify its learnable parameters in order to minimize the loss. The validation set is at least partially different from the training set. The validation set is used for checking the performance of the network on data which was not used to minimize the loss, as an indication of the final performance of the model. In particular, the errors on the training set and on the validation set may be monitored during the training process to understand the following:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model may be in the regime of overfitting. This means that the model has just memorized the training set's properties and performs well only on that set, but performs poorly on a set not used for tuning its parameters.

### Fundamentals of Video/Image Coding

Features as described herein may generally relate to video or image coding. A video codec consists of an encoder that transforms the input video into a compressed representation suited for storage/transmission, and a decoder that can decompress the compressed video representation back into a viewable form. Typically, the encoder discards some information in the original video sequence in order to represent the video in a more compact form (that is, at a lower bitrate).

Typical hybrid video codecs, for example ITU-T H.263 and H.264, encode the video information in two phases. Firstly, pixel values in a certain picture area (or “block”) are predicted, for example by motion compensation means (i.e. finding and indicating an area in one of the previously coded video frames that corresponds closely to the block being coded), or by spatial means (i.e. using the pixel values around the block to be coded in a specified manner). Secondly, the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients, and entropy coding the quantized coefficients. By varying the fidelity of the quantization process, the encoder can control the balance between the accuracy of the pixel representation (i.e. picture quality) and the size of the resulting coded video representation (i.e. file size or transmission bitrate).

Inter prediction, which may also be referred to as temporal prediction, motion compensation, or motion-compensated prediction, exploits temporal redundancy. In inter prediction, the sources of prediction are previously decoded pictures (a.k.a. reference pictures).

In temporal inter prediction, the sources of prediction are previously decoded pictures in the same scalable layer. In intra block copy (IBC; a.k.a. intra-block-copy prediction), prediction may be applied similarly to temporal inter prediction, but the reference picture is the current picture, and only previously decoded samples can be referred in the prediction process. Inter-layer or inter-view prediction may be applied similarly to temporal inter prediction, but the reference picture is a decoded picture from another scalable layer or from another view, respectively. In some cases, inter prediction may refer to temporal inter prediction only, while in other cases inter prediction may refer collectively to temporal inter prediction and any of intra block copy, inter-layer prediction, and inter-view prediction, provided that they are performed with the same or similar process as temporal prediction. Inter prediction, temporal inter prediction, or temporal prediction may sometimes be referred to as compensation motion or motion-compensated prediction.

Intra prediction utilizes the fact that adjacent pixels within the same picture are likely to be correlated. Intra prediction can be performed in the spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors, and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (e.g. using the motion or spatial information created by the encoder and stored in the compressed representation) and prediction error decoding (e.g. inverse operation of the prediction error coding recovering the quantized prediction error signal in the spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In typical video codecs, the motion information is indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those are typically coded differentially with respect to block specific predicted motion vectors. In typical video codecs, the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in the temporal reference pictures, and signaling the chosen candidate as the motion vector predictor. In addition to predicting the motion vector values, the reference index of previously coded/decoded picture can be predicted. The reference index is typically predicted from adjacent blocks and/or or co-located blocks in the temporal reference picture. Moreover, typical high efficiency video codecs employ an additional motion information coding/decoding mechanism, often called merging/merge mode, where all the motion field information, which includes the motion vector and corresponding reference picture index for each available reference picture list, is predicted and used without any modification/correction. Similarly, predicting the motion field information is carried out using the motion field information of adjacent blocks and/or co-located blocks in the temporal reference pictures, and the used motion field information is signaled among a list of motion field candidates filled with motion field information of available adjacent/co-located blocks.

In typical video codecs, the prediction residual after motion compensation is first transformed with a transform kernel (like DCT) and then coded. The reason for this is that, often, there still exists some correlation among the residual and transform can in many cases help reduce this correlation and provide more efficient coding.

Typical video encoders utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding specifications may enable the use of supplemental enhancement information (SEI) messages or alike. Some video coding specifications include SEI network abstraction layer (NAL) units, and some video coding specifications contain both prefix SEI NAL units and suffix SEI NAL units, where the former type can start a picture unit or alike, and the latter type can end a picture unit or alike. An SEI NAL unit contains one or more SEI messages which are not required for the decoding of output pictures but may assist in related processes, such as picture output timing, post-processing of decoded pictures, rendering, error detection, error concealment, and resource reservation. Several SEI messages are specified in H.264/AVC, H. 265/HEVC, H.266/VVC, and H.274/VSEI standards, and the user data SEI messages enable organizations and companies to specify SEI messages for their own use. The standards may contain the syntax and semantics for the specified SEI messages, but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically, and hence interoperate. System specifications may require the use of particular SEI messages both in the encoding end and in the decoding end, and additionally the process for handling particular SEI messages in the recipient may be specified.

### Background Information on Neural Network Based Image/Video Coding

Features as described herein may generally relate to use of NN to code images and/or videos. Recently, neural networks (NNs) have been used in the context of image and video compression, by following mainly two approaches.

In a first approach, NNs are used to replace one or more of the components of a traditional codec, such as a VVC/H.266-compliant codec. Here, by “traditional” or “legacy” we mean those codecs whose components and their parameters are typically not learned from data by means of machine learning techniques. Examples of components that may be implemented as neural networks are: an in-loop filter, for example a NN that works as an additional in-loop filter with respect to the traditional loop filters, or a NN that works as the only additional in-loop filter, thus replacing any other in-loop filter; Intra-frame prediction; inter-frame prediction; transform and/or inverse transform; probability model for lossless coding; etc.

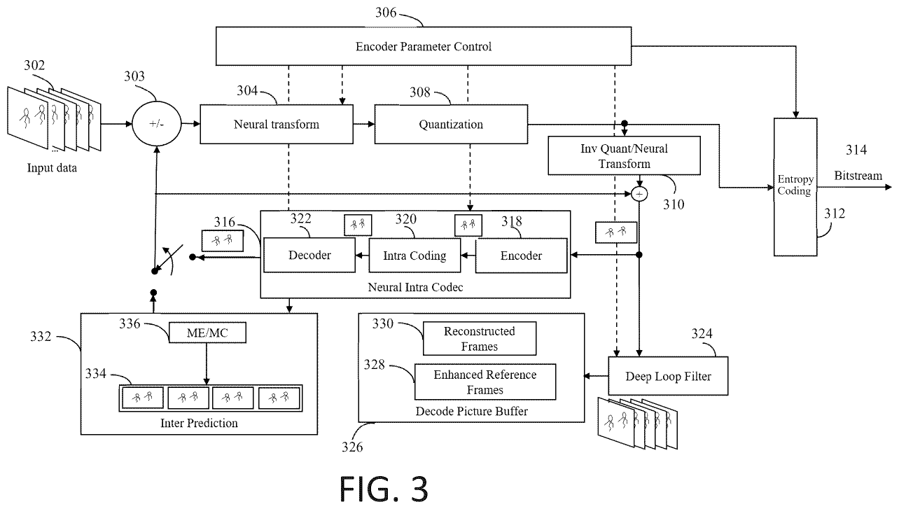

In a second approach, commonly referred to as “end-to-end learned compression” (or end-to-end learned codec), NNs are used as the main components of the image/video codecs. However, the codec may still comprise components which are not based on machine learning techniques. In this second approach, two design options are as follows:
Option 1: re-use the traditional video coding pipeline, but replace most or all the components with NNs. Referring now to FIG. 3, illustrated is an example of an end-to-end learned codec that includes NNs replacing some components of the traditional video coding pipeline. Input signal (x) (302) may be combined (303) with other information and provided to a neural transform (304), which may also receive input from an encoder parameter control (306). Output of the neural transform (304) may be provided for quantization (308), and then for inverse quantization/neural transform (310) as well as entropy coding (312) to a bitstream (314). Entropy coding (312) may be performed based on input from the encoder parameter control (306).

The output of the inverse quantization/neural transform (310) may be combined with other information, and provided to a neural intra codec (316) and to a deep loop filter (324). The neural intra codec (316) may also receive input from the encoder parameter control (306), and may comprise an encoder (318), intra coding (320), and a decoder (322).

The deep loop filter (324) may also receive input from the encoder parameter control (306), and may provide output to a decode picture buffer (326), which may produce an enhanced reference frame (328) based, at least partially, on one or more reconstructed frames (330). The decode picture buffer (326) may provide output for inter prediction (332), which may provide output based, at least partially, on input from the encoder parameter control (306) and ME/MC (336), Gnet (Cnet (•)) (334).

In the example of FIG. 3, the forward and inverse transforms were replaced with two neural networks (304, 310), the intra codec comprises a neural network (316), and the loop filter is a neural network (324).
Option 2: re-design the whole pipeline as a neural network auto-encoder with a quantization and lossless coding in the middle part. This option may also be referred to as end-to-end learned coding. The codec may comprise the following:
Encoder NN (also referred to as a neural network based encoder, or NN encoder): performs a non-linear transformation of the input. The output is typically referred to as a latent tensor.
Quantization and lossless encoding of the encoder NN's output.
Lossless decoding and dequantization.
Decoder NN (also referred to as a neural network based decoder, or NN decoder): inverse performs a non-linear transformation from dequantized latent tensor to a reconstructed input.

It is to be understood that even in end-to-end learned approaches, there may be components which are not learned/trained from data, such as the arithmetic codec.

### Further Information on Neural Network-Based End-to-End Learned Video Coding

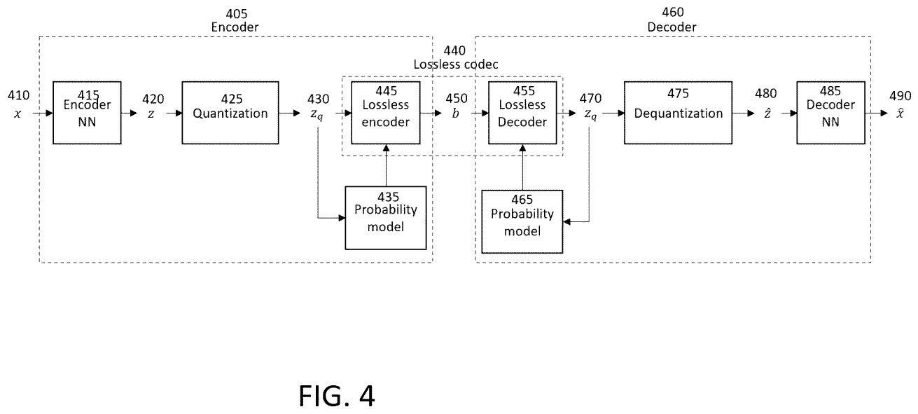

Features as described herein may generally relate to NN-based end-to-end (E2E) learned video codecs. Referring now to FIG. 4, illustrated is an example of neural network-based end-to-end learned coding, such as an end-to-end learned video coding system or an end-to-end learned image coding system.

Even though some examples are provided with respect to coding images or videos, it is to be understood that other types of data may be coded in a similar way, such as audio, speech, text, features, etc. As shown in FIG. 4, a typical neural network-based end-to-end learned coding system contains an encoder (405) and a decoder (460).

The encoder (405) comprises an encoder NN (415), a quantizer or quantization (425), a probability model (435), a lossless encoder (445) (for example arithmetic encoder). The decoder (460) comprises a lossless decoder (455) (for example, an arithmetic decoder), a probability model (465), a dequantizer or dequantization (475), and a decoder NN (485).

It is to be noted that the probability model present at encoder side (435) and the probability model present at decoder side (465) may be the same or substantially the same. For example, they may be two copies of the same probability model. The probability model (435, 465) may also be a neural network and/or may mainly comprise neural network components, and may be referred to as a neural network based probability model or learned probability model.

The lossless encoder (445) and the lossless decoder (455) form a lossless codec (440). A lossless codec may be an entropy-based lossless codec. An example of a lossless codec is an arithmetic codec, such as a context-adaptive binary arithmetic coding (CABAC). Sometimes, the term lossless codec may refer to a system that comprises also the probability model, in addition to, for example, an arithmetic encoder and an arithmetic decoder.

The encoder NN (415) and the decoder NN (485) may typically be two neural networks, or may mainly comprise neural network components.

The quantizer (425), dequantizer (475) and lossless codec (440) are typically not based on neural network components, but may potentially comprise neural network components.

In the example of FIG. 4, the encoder NN (415) may take an input x (410), which may comprise, for example, an image to be compressed. The encoder NN (415) may output a latent tensor z (420). In one example, the latent tensor may be a 3D tensor, where the three dimensions of such tensor may represent a channel dimension, a vertical dimension (also sometimes referred to as height dimension) and a horizontal dimension (also sometimes referred to as width dimension). In another example, the latent tensor may be a 4D tensor, where the four dimensions of such tensor may represent sample dimension (also sometimes referred to as batch dimension, which is the dimension along which different samples of data can be placed), a channel dimension, a vertical dimension (also sometimes referred to as height dimension) and a horizontal dimension (also sometimes referred to as width dimension). The latent tensor (420) may be input to a quantization operation (425), obtaining a quantized latent tensor z_{q} (430). The quantized latent tensor (430) may be lossless-encoded into a bitstream b (450) by the lossless encoder (445), based also on the output of the probability model (435). In particular, the probability model may take as input at least part of the quantized latent tensor (430) and may output an estimate of a probability, or an estimate of a probability distribution, or an estimate of one or more parameters of a probability distribution, for one or more elements of the quantized latent tensor. The bitstream (450) may represent an encoded or compressed version of the input x (410).

The bitstream (450) may be lossless-decoded by the lossless decoder (455) also based on the output of the probability model present at decoder side (465), obtaining a quantized latent tensor z_{q} (470). The quantized latent tensor may be dequantized (475), obtaining a reconstructed latent tensor \hat{z} (480). The reconstructed latent tensor (480) may be input to a decoder NN (485), obtaining a reconstructed input \hat{x} (490), i.e., a reconstructed version of the input x (410). The reconstructed input (490) may also be referred to as reconstructed data, or reconstruction, or decoded data, or decoded input, or decoded output, and the like.

FIG. 4 presents a simplified description of an end-to-end learned codec; more sophisticated designs, or variations of this design, are possible.

The neural network components, or a subset of the neural network components, of an end-to-end learned codec may be trained by minimizing a rate-distortion loss function:

$$L = D + λ R$$

where D is a distortion loss term, R is a rate loss term, and λ is a weight that controls the balance between the two losses. The distortion loss term may be referred to also as reconstruction loss term, or simply reconstruction loss. The rate loss term may be referred to simply as rate loss.

The distortion loss term measures the quality of the reconstructed or decoded output, and may comprise (but may not be limited to) one or more of the following:
Mean square error (MSE)
Structure similarity index measure (SSIM)
Multiscale structure similarity index measure (MS-SSIM)
Losses derived from the use of a pretrained neural network. For example, error (f1, f2), where f1 and f2 are the features extracted by a pretrained neural network for the input data and the decoded data, respectively, and error ( ) is an error or distance function, such as L1 norm or L2 norm.
Losses derived from the use of a neural network that is trained simultaneously with the end-to-end learned codec. For example, adversarial loss can be used, which is the loss provided by a discriminator neural network that is trained adversarially with respect to the codec, following the settings proposed in the context of Generative Adversarial Networks (GANs) and their variants.
Loss that is related to a performance of one or more machine analysis tasks or to an estimated performance of one or more machine analysis tasks, where the one or more machine analysis tasks may comprise classification, object detection, image segmentation, instance segmentation, etc. In one example, the estimated performance of one or more machine analysis tasks may comprise a distortion computed based at least on a first set of features extracted from an output of the decoder, and a second set of features extracted from a respective ground truth data, where the first set of features and the second set of features are output by one or more layers of a pretrained feature-extraction neural network.

Multiple distortion losses may be used and integrated into D, such as a weighted sum of MSE and SSIM.

The rate loss term may be used to train the encoder NN to output a low-entropy latent tensor, or a latent tensor such that the quantized latent tensor has low entropy, or a latent tensor such that the probability distribution of the quantized latent tensor may be better estimated or predicted by the probability model.

The rate loss term may be used to train the probability model to better estimate or predict the probability distribution of the quantized latent tensor.

Examples of the rate loss terms include the following:
In one example, the rate loss term may be derived from the output of the probability model, and it may represent the estimated entropy of the quantized latent representation, which may indicate the number of bits necessary to represent the quantized latent tensor.
A sparsification loss, i.e., a loss that encourages the quantized latent tensor to comprise many zeros. Examples are L0 norm, L1 norm, L1 norm divided by L2 norm.

In order to train the neural network components, or a subset of the neural network components, of an end-to-end learned codec, one or more of reconstruction losses may be used, and one or more rate losses may be used. In one example, the one or more reconstruction losses and/or one or more rate losses may be combined by means of a weighted sum. Typically, the different loss terms are weighted using different weights, and these weights determine how the final system performs in terms of rate-distortion performance. For example, if more weight is given to the reconstruction losses with respect to the rate losses, the system may learn to compress less, but to reconstruct with higher accuracy (e.g. as measured by a metric that correlates with the reconstruction losses). These weights are usually considered to be hyper-parameters of the training process, and may be set manually by the person designing the training process, or automatically, for example by grid search or by using additional neural networks.

In one case, the training process may be performed jointly with respect to the distortion loss D and the rate loss R. In another case, the training process may be performed in two alternating phases, where in a first phase only the distortion loss D may be used, and in a second phase only the rate loss R may be used.

For lossless video/image compression, the system may only comprise the probability model and lossless encoder and lossless decoder. The loss function would comprise only the rate loss, since the distortion loss is always zero (i.e., no loss of information).

In the present disclosure, we refer to inference phase, or inference stage, or inference time, or test time, the phase when a neural network or a codec is used for its purpose, such as encoding and decoding an input image.

### Background Information on Video Coding for Machines (VCM)

Features as described herein may generally relate to video coding for machines (VCM). Reducing the distortion in image and video compression is often intended to increase human perceptual quality, as humans are considered to be the end users, i.e. consuming/watching the decoded images or videos. Recently, with the advent of machine learning, especially deep learning, there is a rising number of machines (i.e., autonomous agents) that analyze data independently from humans, and may even make decisions based on the analysis results without human intervention. Examples of such analysis are object detection, scene classification, semantic segmentation, video event detection, anomaly detection, pedestrian tracking, etc. For example, such analysis tasks may be performed by neural networks.

It is likely that the device where the analysis takes place has multiple “machines” or neural networks (NNs). These multiple machines may be used in a certain combination which is, for example, determined by an orchestrator sub-system. The multiple machines may be used, for example, in succession, based on the output of the previously used machine, and/or in parallel. For example, a video may be analyzed by one machine (NN) for detecting pedestrians, by another machine (another NN) for detecting cars, and by another machine (another NN) for estimating the depth of all the pixels in the frames.

Example use cases and applications are self-driving cars, video surveillance cameras and public safety, smart sensor networks, smart TV and smart advertisement, person re-identification, smart traffic monitoring, drones, etc. In addition to image and video data, automatic analysis and processing is increasingly being performed for other types of data, such as audio, speech, text.

Compressing (and decompressing) data where the end user comprises machines (e.g., neural networks) is commonly referred to as compression or coding for machines. In the case of video data, it is referred to as video compression or coding for machines (VCM). Compressing for machines may differ from compressing for humans, for example, with respect to the algorithms and technology used in the codec, or the training losses used to train any neural network components of the codec, or the evaluation methodology of codecs.

It is to be understood that, when considering the case of coding for machines, we use the term “receiver-side” or “decoder-side” to refer to the physical or abstract entity or device which contains one or more machines, and runs these one or more machines on some encoded and eventually decoded video representation which is encoded by another physical or abstract entity or device, the “encoder-side device”.

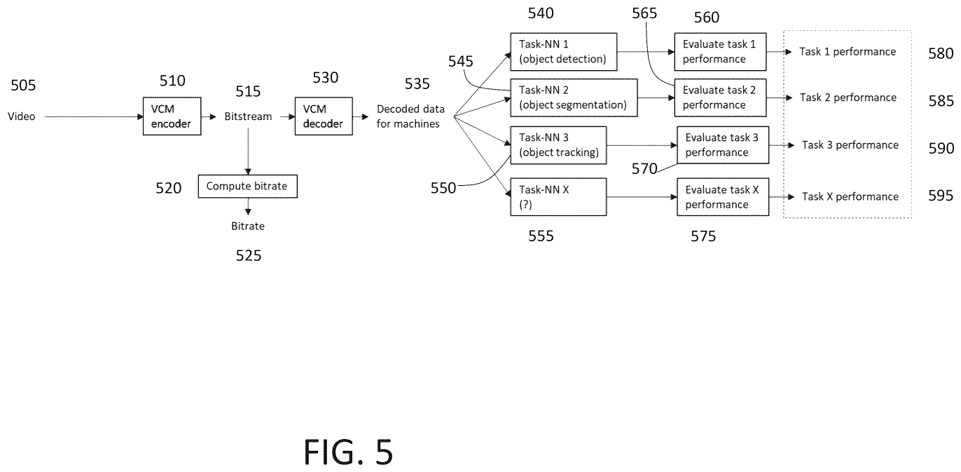

Referring now to FIG. 5, illustrated is an example of a pipeline of video coding for machines. A VCM encoder (510) may encode the input video (505) into a bitstream (515). A bitrate (525) may be computed (520) from the bitstream (515), as a measure of the size of the bitstream. A VCM decoder (530) may decode the bitstream (515) that was produced by the VCM encoder (510).

The output of the VCM decoder (530) may be referred to as “Decoded data for machines” (535). This data may be considered as the decoded or reconstructed video. However, in some implementations of this pipeline, this data may not have same or similar characteristics as the original video which was input to the VCM encoder. For example, this data may not be easily understandable by a human by simply rendering the data onto a screen, if such rendering is possible.

The output (535) of the VCM decoder (530) may then be input to one or more task neural networks (540, 545, 550, 555). In FIG. 5, for the sake of illustrating that there may be any number of task-NNs, there are three example task-NNs, and a non-specified one (Task-NN X, 555). One goal of VCM may be to obtain a low bitrate while guaranteeing that the task-NNs still perform well (580, 585, 590, 595) in terms of the evaluation metric associated to each task (560, 565, 570, 575).

It is to be understood that, in some cases, the VCM decoder may not be present. In one example, the machines may be run directly on the bitstream. In some other cases, the VCM decoder may comprise only a lossless decoding stage, and the lossless decoded data may be provided as input to the machines. In yet some other cases, the VCM decoder may comprise a lossless decoding stage following by a dequantization operation, and the loss-decoded and dequantized data may be provided as input to the machines.

When a conventional video encoder, such as a H.266/VVC encoder, is used as a VCM encoder, one or more of the following approaches may be used to adapt the encoding to be suitable to machine analysis tasks:
One or more regions of interest (ROIs) may be detected. An ROI detection method may be used. For example, ROI detection may be performed using a task NN, such as an object detection NN. In some cases, ROI boundaries of a group of pictures or an intra period may be spatially overlaid and rectangular areas may be formed to cover the ROI boundaries. The detected ROIs (or rectangular areas, likewise) may be used in one or more of the following ways: the quantization parameter (QP) may be adjusted spatially in a manner that ROIs are encoded using finer quantization step size(s) than other regions. For example, QP may be adjusted CTU-wise; the video may be preprocessed to contain only the ROIs, while the other areas may be replaced by one or more constant values or removed; the video may be preprocessed so that the areas outside the ROIs are blurred or filtered; or, a grid may be formed in a manner that a single grid cell covers a ROI. Grid rows or grid columns that contain no ROIs may be downsampled as preprocessing to encoding.
Quantization parameter of the highest temporal sublayer(s) may be increased (i.e. coarser quantization is used) when compared to practices for human watchable video.
The original video may be temporally downsampled as preprocessing prior to encoding. A frame rate upsampling method may be used as postprocessing subsequent to decoding, if machine analysis at the original frame rate is desired.
A filter may be used to preprocess the input to the conventional encoder. The filter may be a machine learning based filter, such as a convolutional neural network.

It is to be understood that, in the context of video coding for machines, the terms “machine vision”, “machine vision task”, “machine task”, “machine analysis”, “machine analysis task”, “computer vision”, “computer vision task”, “task network” and “task” may be used interchangeably. Also, it is to be understood that, in the context of video coding for machines, the terms “machine consumption” and “machine analysis” may be used interchangeably.

### Background on Neural Network Based Filtering

A neural network may be used for filtering or processing input data. We may refer to such a neural network as a neural network based filter, or simply as a NN filter. A NN filter may comprise one or more neural networks, and/or one or more components that may not be categorized as neural networks (i.e. may be categorized as traditional or legacy components that are not trained based on data using machine learning techniques). The purpose of a NN filter may comprise (but may not be limited to) visual enhancement, colorization, upsampling, super-resolution, inpainting, temporal extrapolation, generating content, or the like.

In some video codecs, a neural network may be used as filter in the encoding and decoding loop (also referred to simply as coding loop), and it may be referred to as a neural network loop filter, or a neural network in-loop filter. The NN loop filter may replace all other loop filters of an existing video codec, or may represent an additional loop filter with respect to the already present loop filters in an existing video codec.

A neural network filter may be used as a post-processing filter for a codec, e.g., may be applied to an output of an image or video decoder in order to remove or reduce coding artifacts.

In one example, a codec is a modified VVC/H.266 compliant codec (e.g., a VVC/H.266 compliant codec that has been modified and thus it may not be compliant to the VVC/H.266) that comprises one or more NN loop filters. An input to the one or more NN loop filters may comprise at least a reconstructed block or frames (simply referred to as reconstruction) or data derived from a reconstructed block or frame (e.g., the output of a conventional loop filter). The reconstruction may be obtained based on predicting a block or frame (e.g., by means of intra-frame prediction or inter-frame prediction) and performing residual compensation. The one or more NN loop filters may enhance the quality of at least one of their input, so that a rate-distortion loss is decreased. The rate may indicate a bitrate (estimate or real) of the encoded video. The distortion may indicate a pixel fidelity distortion such as the following:
Mean-squared error (MSE).
Mean absolute error (MAE).
Mean Average Precision (mAP) computed based on the output of a task NN (such as an object detection NN) when the input is the output of the post-processing NN.
Other machine task-related metric, for tasks such as object tracking, video activity classification, video anomaly detection, etc.

The enhancement may result into a coding gain, which may be expressed for example in terms of BD-rate or BD-PSNR (peak signal-to-noise ratio).

A neural network filter may be used as a post-processing filter for a codec, e.g., may be applied to an output of an image or video decoder in order to remove or reduce coding artifacts. In one example, the NN filter may be used as a post-processing filter where the input comprises data that is output by or is derived from an output of a traditional decoder, such as a decoder that is compliant with the VVC/H.266 standard. In another example, the NN filter may be used as a post-processing filter where the input comprises data that is output by or is derived from an output of a decoder of an end-to-end learned decoder.

### Input to a NN Filter

Various input may be provided to a NN filter. In the case of filtering images, a filter may take as input at least one or more first images to be filtered and may output at least one or more second images, where the one or more second images are the filtered version of the one or more first images. In one example, the filter may take as input one image, and output one image. In another example, the filter may take as input more than one image, and output one image. In another example, the filter may take as input more than one image, and output more than one image.

It is to be understood that a filter may take as input also other data (also referred to as auxiliary data, or extra data) besides the data that is to be filtered, such as data that may aid the filter to perform a better filtering than if no auxiliary data was provided as input. In one example, the auxiliary data may comprise information about prediction data, and/or information about the picture type, and/or information about the slice type, and/or information about a Quantization Parameter (QP) used for encoding, and/or information about boundary strength, etc. In one example, the filter may take as input one image and other data associated to that image, such as information about the quantization parameter (QP) used for quantizing and/or dequantizing that image, and output one image.

### Background Information on Overfitting a Neural Network Filter

Features as described herein may generally relate to adaptation of a NN. A NN filter may be adapted at test time based at least on part of the data to be encoded and/or decoded and/or post-processed. Such operation may be referred to, for example, with one of the following terms, when their meaning is clear from the context: adaptation, content adaptation, overfitting, finetuning, optimization, specialization, and the like.

Although, for simplicity, the case of a NN filter is being considered herein, similar adaptation may be performed for other coding tools and/or post-processing tools that are based on neural network technology. For example, a neural network based intra-frame prediction, or a neural network based inter-frame prediction, etc.

The NN filter that results from the adaptation process may be referred to, for example, with one of the following terms: adapted filter, content-adapted filter, overfitted filter, finetuned filter, optimized filter, specialized filter, and the like.

At the encoder side, the adaptation process may start with an initial NN filter. In one example, the initial NN filter may be a pretrained NN filter that was pretrained during an offline stage on a sufficiently large dataset. In another example, the initial NN filter may be a randomly initialized NN filter.

In the adaptation, one or more parameters of the NN filter may be adapted. Examples of such parameters may include (but may not be limited to) the following: the bias terms of a convolutional neural network; multiplier parameters that multiply one or more tensors produced by the NN filter, such as one or more feature tensors that are output by respective one or more layers of the NN filter; parameters of the kernels of a convolutional neural network; parameters of an adapter layer; or one or more arrays or tensors that are used as input to respective one or more layers of the NN filter.

The adaptation may be performed by means of a training process, e.g., by minimizing a loss function until a stopping criterion is met. The data used for this training process may comprise one or more pictures or blocks of input to the NN filter and associated respective one or more pictures or blocks of ground-truth data. In one example where the filter is an in-loop filter, the input to the NN filter may be reconstruction data, after prediction and residual compensation; the ground-truth data may be the uncompressed data that is given as input to the encoder. In one example where the filter is a post-processing filter, the input to the NN filter may be decoded data (e.g., the output of a video decoder); the ground-truth data may be the uncompressed data that is given as input to the encoder.

The loss function used during the training process may comprise one or more distortion loss functions (also referred to as reconstruction loss functions) and zero or more rate loss functions. A rate loss function may measure, for example, the cost in terms of bitrate of signaling any adaptation signal, such as updates to the parameters of the NN filter. A distortion loss function may comprise one of MSE, MS-SSIM, Video Multimethod Assessment Fusion (VMAF), etc.

The adaptation signal may be derived based on the adapted NN filter and on the original NN filter (i.e., the NN filter before the overfitting process). In one example, the adaptation signal comprises an update to one or more parameters of the NN filter. We may refer to such update also as weight update, or parameter update. Such update may be computed, for example, by subtracting the values of the adapted parameters (i.e., the parameters of the adapted NN filter) from the corresponding values of the original parameters (i.e., the parameters of the original NN filter). In another example, the adaptation signal may comprise the parameters (of the NN filter) that were adapted, also referred to as updated parameters, or adapted parameters, or adapted weights, or overfitted parameters, and the like.

In order to keep the size of the adaptation signal low, the adaptation signal may go through one or more compression steps, such as sparsification, quantization and lossless coding, etc. In one example, an encoder that compresses the adaptation signal into a bitstream that is compliant with a neural network compression standard, such as MPEG neural network coding (NNC), may be used.

The compressed adaptation signal may be signaled from encoder to decoder in or along a bitstream that represents encoded image or video data. In one example, the compressed adaptation signal may be signaled in an Adaptation Parameter Set (APS) syntax structure of a video coding bitstream. In another example, the compressed adaptation signal may be signaled in a Supplemental Enhancement Information (SEI) message of a video coding bitstream. Signaling may comprise also other information which is associated with the adaptation signal and that may be required for correctly parsing and/or decompressing and/or using the adaptation signal, such as any quantization parameters.

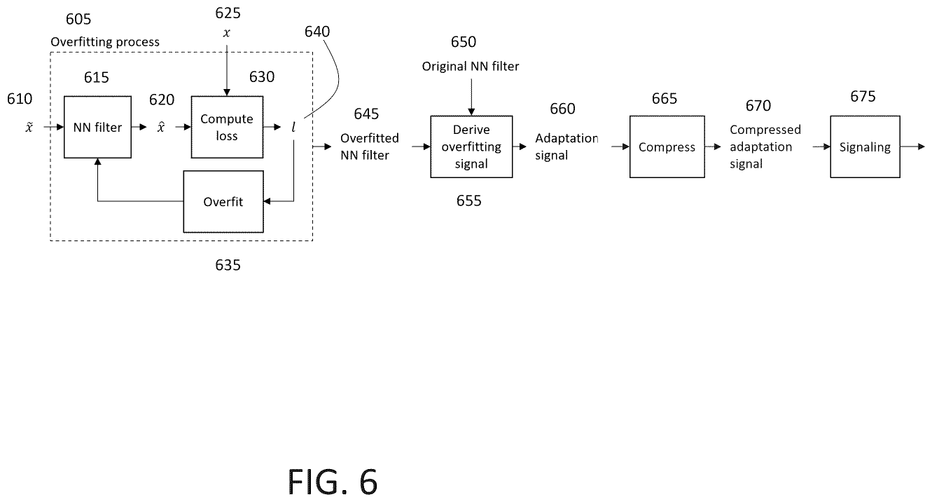

Referring now to FIG. 6, illustrated is an example of an overfitting process (605) at the encoder side. The overfitting process (605) may be performed at the encoder side based on a training process. Input (610) may be provided to a NN filter (615) to determine an output (620). Loss (640) may be computed (630) between ground truth (625) and the output (620). The loss (640) may be provided to determine overfitting (635), which may be provided to the NN filter (615).

The resulting overfitted filter (645) may then be used to derive an overfitting signal (655), or adaptation signal (660). The overfitting signal may be derived based partially on the original NN filter (650). The adaptation signal (660) may be compressed (665) to determine a compressed adaptation signal (670) and then signaled (675) from the encoder to the decoder, in or along a bitstream that represents encoded data, such as an encoded image or video.

In the example of FIG. 6, \tilde{x} (610) represents an input to the NN filter, \hat{x} (620) represents an output of the NN filter (615), x (625) represents a ground-truth data associated with \tilde{x} (610), “Compute loss” (630) may compute a training loss 1 (640) in order to overfit the NN filter, and “Overfit” (635) may use 1 (640) to overfit the NN filter (615). As a result of the overfitting process (605), an overfitted NN filter may be obtained (645), which may be used (655), together with the original NN filter (650), to derive an adaptation signal (660). The adaptation signal may be compressed (665) and signaled (675) to a decoder or receiver.

At the decoder or receiver side, the signaled compressed adaptation signal may be received and decompressed. The decompressed adaptation signal may then be used to update the NN filter. In one example, where the adaptation signal may comprise a weight update, where the weight update may comprise one or more updates to respective one or more parameters of the NN filter, the one or more updates may be added to the one or more parameters. In another example, where the adaptation signal may comprise one or more updated or adapted parameters, the one or more updated or adapted parameters may be used to replace respective one or more parameters of the NN filter.

Once the NN filter has been updated based on the adaptation signal, the updated NN filter may be used for its purpose. For example, for filtering an input picture or an input block.

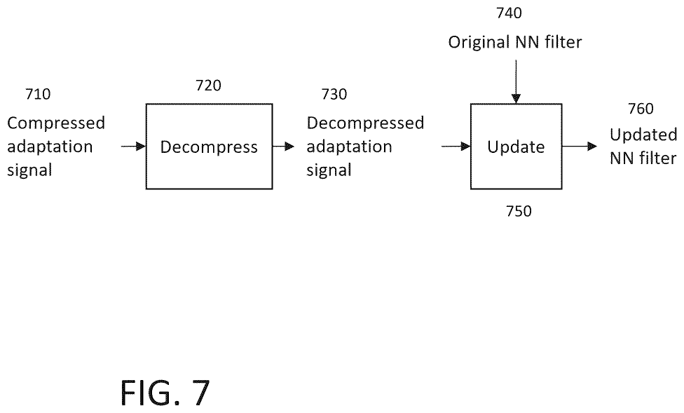

Referring now to FIG. 7, illustrated is an example of use of an adaptation signal for overfitting at the decoder or receiver side. A compressed adaptation signal (710) may be decompressed (720) to derive a decompressed adaptation signal (730). At the decoder side, the overfitting signal (730), or a signal derived from the overfitting signal, may be used to update (750) the NN filter (740). The updated NN filter (760) may then be used to filter one or more pictures, or one or more blocks.

In the examples of FIGS. 6-7, the NN filter that is obtained from the overfitting process at encoder side may be different from the NN filter that is obtained from the updating process at decoder side. For example, one reason may be that the adaptation signal may be compressed in a lossy way. Thus, the former NN filter may be referred to as overfitted filter or adapted filter (or other similar terms, see above), and the latter NN filter may be referred to as updated filter.

In the present disclosure, the terms frame, picture and image may be used interchangeably. For example, the input and output to an end-to-end learned codec may be pictures. The input and output of a NN filter may be pictures. It is to be understood that also the term block, when it means a portion of a picture, may be simply referred to as frame or picture or image. In other words, at least some of the embodiments herein, even when described as applied to a picture, may be applicable also to a block, e.g., to a portion of a picture.

Example embodiment of the present disclosure may consider image and video as the data types. However, this is not limiting; the example embodiments may be extended to other types of data, such as audio.

For simplicity, image and video data may be collectively referred to as visual data, and it is to be understood that visual data may refer to either image data or video data or both.

In the present disclosure, the terms signal, data and tensor may be used interchangeably to indicate an input or an output.

In the present disclosure, an end-to-end learned codec may be referred to also as E2E learned codec, or learned codec, or E2E codec.

In the present disclosure, neural network layers may be simply referred to as layers, or sets of layers.

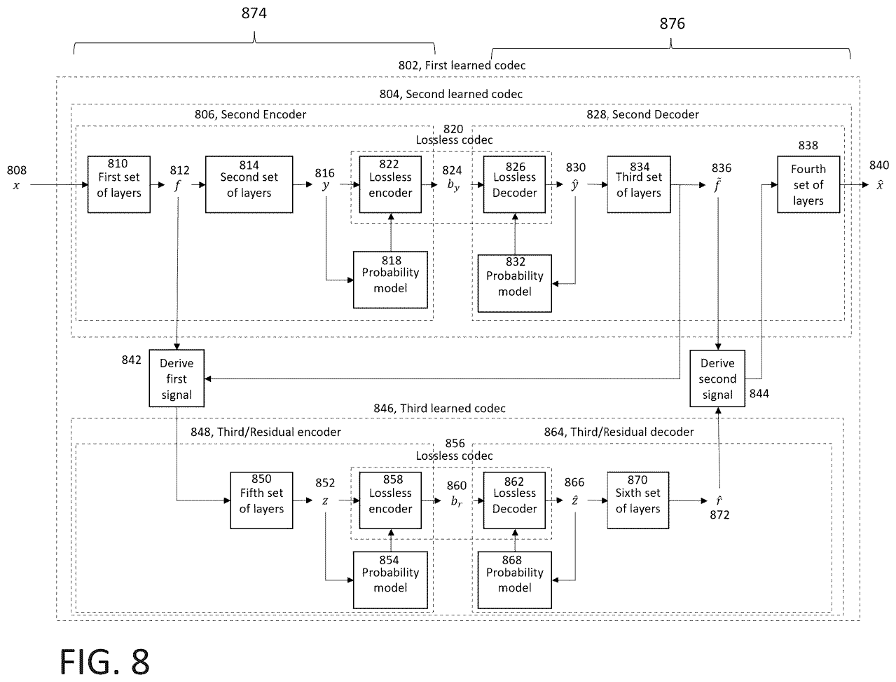

Referring now to FIG. 8, illustrated is an example of an end-to-end learned codec according to an example embodiment of the present disclosure. Note that quantization and dequantization operations are not illustrated for simplicity. Also, some modules/blocks such as first lossless encoder, second lossless encoder, etc., are simply referred to as “Lossless encoder”, etc., in FIG. 8 for simplicity.

In an example embodiment, a first learned codec (802) may comprise a second learned codec (804) and a third learned codec (846). The second learned codec (804) may comprise a second encoder (806) and a second decoder (828). The third learned codec (846) may comprise a third encoder (848) and a third decoder (864). A first encoder (874) of the first learned codec (802) may comprise the second encoder (806) and the third encoder (848). A first decoder (876) of the first learned codec (802) may comprise the second decoder (828) and the third decoder (864).

An input (808) to the first encoder (874) may comprise a data item to be encoded, such as a picture to be encoded. An output of the first encoder (874) may comprise a first bitstream, where the first bitstream may comprise a second bitstream (824) that may be output by the second encoder (806) and a third bitstream (860) that may be output by the third encoder (848). The first bitstream may represent an encoded data item, such as an encoded picture. An input to the first decoder (876) may comprise the first bitstream. An output of the first decoder (876) may comprise a decoded data item (840), such as a decoded picture.

The second encoder (806) may comprise a first set of layers (810), a second set of layers (814), a first quantization operation, a first probability model (818), and a first lossless encoder (822). The second decoder (828) may comprise a first lossless decoder (826), a first dequantization operation, a probability model (832) that is same or substantially same as the first probability model (818), a third set of layers (834) and a fourth set of layers (838).

An input to the first set of layers (810) may comprise the data item to be encoded (808), such as a picture. An output of the first set of layers, referred to also as first set of features (812), may be input to the second set of layers (814). The first set of features may be considered an intermediate output. An output of the second set of layers may be a first latent tensor (816) that may be quantized and lossless coded (822), obtaining the second bitstream (824). The first latent tensor (816), or a portion of the first latent tensor, may also be provided to the probability model, which may determine information for the lossless encoder (822) based on the first latent tensor or based on the portion of the first latent tensor. The quantized and lossless coded first latent tensor, or the second bitstream (824), may be input to the decoder (826) of the second learned codec (828). The quantized and lossless coded first latent tensor, or the second bitstream (824), may be lossless decoded (826) and dequantized, to obtain the lossless decoded and dequantized first latent tensor (830). An input to the third set of layers (834) may be the lossless decoded and dequantized first latent tensor (830). The lossless decoded and dequantized first latent tensor (830), or a portion of the lossless decoded and dequantized first latent tensor, may also be provided to the probability model (832), which may provide input to the lossless decoder (826). An output of the third set of layers may also be referred to as second set of features (836).

In an example embodiment, the first set of layers (810) and the second set of layers (814) may comprise separate neural networks. Alternatively, the first set of layers (810) and the second set of layers (814) may comprise a same neural network, for example may comprise respective two portions of a same neural network.

In an example embodiment, the third set of layers (834) and the fourth set of layers (838) may comprise separate neural networks. Alternatively, the third set of layers (834) and the fourth set of layers (838) may comprise a same neural network, for example may comprise respective two portions of a same neural network.

The third encoder (846) may comprise a fifth set of layers (850), a second quantization operation, a second lossless encoder (858), and a second probability model (854). The third decoder (864) may comprise a second lossless decoder (862), a second dequantization operation, a probability model (868) that is same or substantially same as the second probability model (854), and a sixth set of layers (870).

A first signal may be derived (842) from the first set of features (812) and from the second set of features (836) and may be input to the fifth set of layers (850). An output of the fifth set of layers (850) may be a second latent tensor (852) that may be quantized and lossless coded (858), obtaining the third bitstream (860). The second latent tensor (852), or a portion of the second latent tensor, may also be provided to the probability model (854), which may determine input for the lossless encoder (858) based at least on the second latent tensor (852) or on the portion of the second latent tensor. The quantized and lossless coded second latent tensor, or the third bitstream (860), may be input to the decoder (864) of the third learned codec (846). The quantized and lossless coded second latent tensor, or the third bitstream (860), may be lossless decoded (862) and dequantized to obtain a lossless decoded and dequantized second latent tensor (866). An input to the sixth set of layers (870) may be the lossless decoded and dequantized second latent tensor (866). The lossless decoded and dequantized second latent tensor (866), or a portion of the lossless decoded and dequantized second latent tensor, may also be provided to the probability model (868), which may determine input for the lossless decoder (862) based at least on the lossless decoded and dequantized second latent tensor (866), or a portion of the lossless decoded and dequantized second latent tensor.

A second signal may be derived (844) from an output (872) of the sixth set of layers (870) and/or from the second set of features (836) and may be input to the fourth set of layers (838). This process may be considered a refinement, in the feature-space, of the second set of features (836). An output (840) of the fourth set of layers (838) may comprise an output of the second decoder (828) and/or an output of the first decoder (876), which may represent a decoded data item, such as a decoded picture.

In an example embodiment, the third learned codec (846) may be referred to as a residual codec, the third encoder (848) may be referred to as a residual encoder, and the third decoder (864) may be referred to as a residual decoder. The first signal may represent a residual information in the feature domain, or a residual information between the first set of features (812) and the second set of features (836). The third bitstream (860) may represent an encoded residual information. An output of the residual decoder (864), such as the output (872) of the sixth set of layers (870), may represent a decoded residual information.

In the example of FIG. 8, x (808) represents an input data item to be encoded, such as a picture, and \hat{x} (840) represents a respective decoded data item, such as a decoded picture. b_{y} (824) and bᵣ (860) are two bitstreams that represent an encoded data item, such as an encoded picture. It is to be noticed that, in some embodiments, the derivation of the first signal and the second signal, represented by blocks “Derive first signal” (842) and “Derive second signal” (844), respectively, may be comprised or integrated into respective two other modules or blocks of FIG. 8; for example, the module “Derive first signal” may be included into first set of layers (810) or into the fifth set of layers (850) or into the third encoder (848), and the module “Derive second signal” may be included into the sixth set of layers (870) or into the third decoder (864) or into the fourth set of layers (838).

In an example embodiment, the first learned codec (802) may be an image codec. In another embodiment, the first learned codec (802) may be an intra-frame codec that may be used as part of a video codec for coding intra frames. The video codec may comprise another module or codec that codes inter frames, where the another module or codec may be one of a learned codec or a non-learned codec, or a combination of a learned codec and a non-learned codec.

In an example embodiment, the second set of features (836) may represent an initial reconstruction of features of decoded data, such as an initial reconstruction of features of a decoded picture.

In an example embodiment, one or more data sub-units of a data unit (or one or more portions of a data unit) may be encoded and/or decoded without using the third learned codec (and any associated operations, such as deriving the first signal and deriving the second signal), e.g., by using only the second learned codec. In one example, where a data unit is a video, zero or more first pictures comprised in the video may be coded by using the whole first learned codec (comprising both the second learned codec and the third learned codec), and zero or more second pictures comprised in the video may be coded by using only the second learned codec (e.g., the third learned codec is not used) or, in other words, by using the first learned codec but excluding the third learned codec and the derivations of the first and second signals. For example, at least part of an input data item may be determined based on at least part of the second set of features, but not (i.e. excluding) on the decoded residual information.

In an example embodiment, one or more data sub-units of a data unit (or one or more portions of a data unit) may be encoded and/or decoded without using all the operations and layers of the second learned codec. In particular, a first signal may be derived based on a first set of features extracted from a first portion of a data unit using the first set of layers and on a second set of features extracted based on a previously-coded second portion of the data unit. Alternatively, a first signal may be derived based on a first set of features extracted from a first portion of a data unit using the first set of layers and on a second signal that was derived based on a previously-coded second portion of the data unit. A second signal for the first portion of the data unit may be derived based on a decoded residual information for the first portion of the data unit and on the second set of features extracted based on the previously-coded second portion of the data unit. Alternatively, a second signal for the first portion of the data unit may be derived based on a decoded residual information for the first portion of the data unit and on the second signal that was derived based on the previously-coded second portion of the data unit.

In one example, where a data unit may be a video, a first picture (which may be referred to also as a previously-coded picture) comprised in the video may be coded by using the whole first learned codec. The second signal that is derived during the decoding of the first picture may be stored in memory and may be referred to as a previous second signal. A second picture (which may be referred to also as a current picture or currently-coded picture) comprised in the video may be coded by using a subset of the second learned codec and based on previously-decoded information as follows. A first signal for the current picture (which may also be referred to as current first signal, or current residual information) may be derived based on a first set of features (which may also be referred to as current first set of features, and extracted based on the current picture) and on the previous second signal. Decoded residual information for the current picture (also referred to as current decoded residual information) may be determined based on the current first signal. A second signal for the current picture (which may also be referred to as current second signal) may be derived based on the previous second signal and the current decoded residual information. The current picture may be decoded based on the current second signal. Thus, the subset of the second learned codec that is used to code the current picture may exclude the second set of layers, the lossless encoder and lossless decoder of the second learned codec, the probability model of the second encoder and the probability model of the second decoder, and the third set of layers. In other words, the current picture may be encoded into a bitstream that comprises only the third bitstream that is output by the third encoder. In yet other words, the current picture may be coded as residual information with respect to the second set of features or the second signal extracted from or derived based on the previously-coded picture.

In an example embodiment, an encoder (such as the first encoder) may signal or encode to a decoder (such as the first decoder), in or along a bitstream, and the decoder may receive or decode, from or along the bitstream, information indicating whether and how at least a portion of a data unit is to be decoded by excluding at least part of the third decoder (e.g. decoding information from the first bitstream and not applying (or not making use of) at least one of: decoded residual information, and/or a sixth set of layers, to the decoded information). The information may further indicate a spatial and/or temporal scope. In one example, such information may comprise a flag (e.g., represented as one bit) or an index (e.g., represented as several bits). In one example, a specification of a standard may specify or comprise a mapping between the information (e.g., the flag or the index or an indicator) and a respective decoding mode or decoding configuration, where the decoding mode or decoding configuration may comprise one or more decoding steps or decoding operations.

In an example embodiment, an encoder (such as the first encoder) may signal or encode to a decoder (such as the first decoder), in or along a bitstream, and the decoder may receive or decode, from or along the bitstream, information indicating whether and how at least a portion of a data unit is to be decoded by excluding at least part of the second decoder (e.g. decoding information from the first bitstream and not applying (or not making use of) at least one of: a third set of layers, and/or a second set of features, to the decoded information). The information may further indicate a spatial and/or temporal scope. In one example, such information may comprise a flag (e.g., represented as one bit) or an index (e.g., represented as several bits). In one example, a specification of a standard may specify or comprise a mapping between the information (e.g., the flag or the index or an indicator) and a respective decoding mode or decoding configuration, where the decoding mode or decoding configuration may comprise one or more decoding steps or decoding operations.

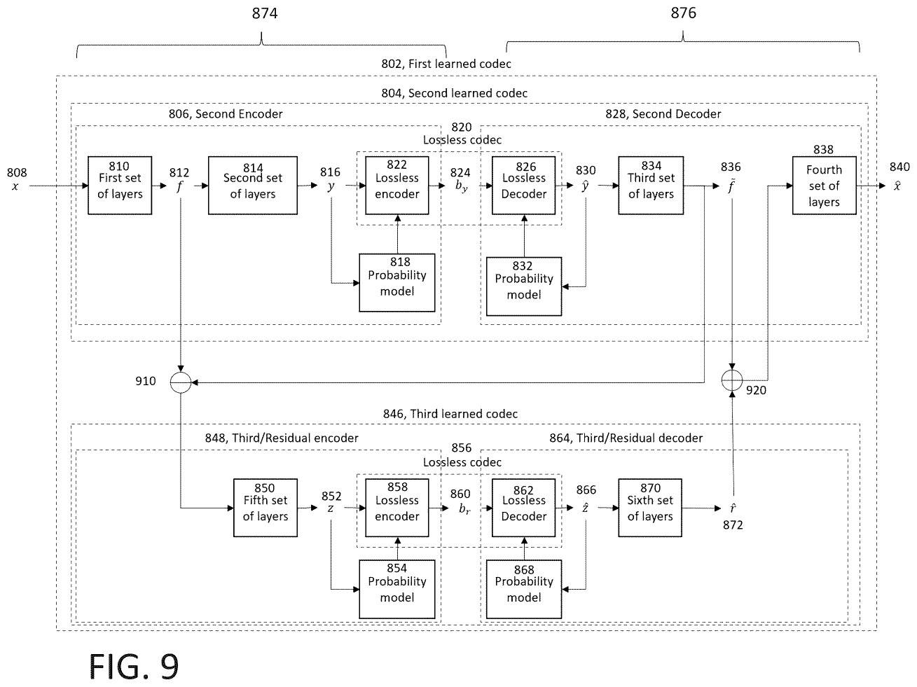

In an example embodiment, the residual may be explicitly derived. Referring now to FIG. 9, illustrated is an example of an end-to-end learned codec according to an example embodiment of the present disclosure. Features of FIG. 9 that are similar to FIG. 8 are referred to with the same reference numbers, and duplicative description is omitted.

In an example embodiment, the first signal, that is derived from the first set of features (812) and from the second set of features (836), may comprise a result of an element-wise subtraction or difference (910) between the first set of features (812) and the second set of features (836).

In one embodiment, the second signal, that is derived from the second set of features (836) and from an output (872) of the third decoder (864), may comprise a result of an element-wise addition (e.g., summation) (920) between the second set of features (836) and the output (872) of the third decoder (864).

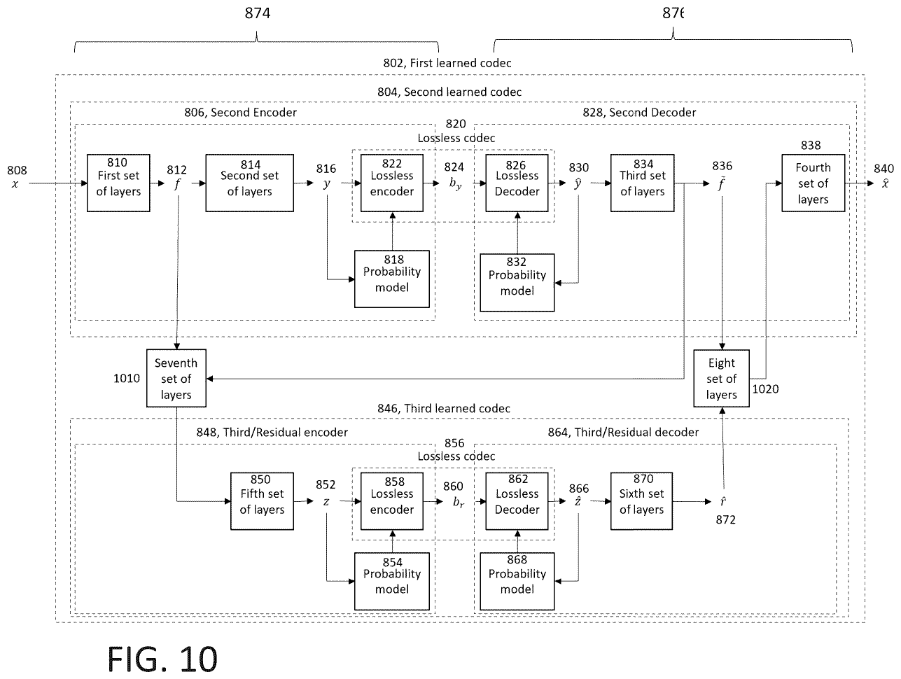

In an example embodiment, the residual or first signal may be derived based on a learned derivation operation, such as by means of a neural network or a portion of a neural network. Referring now to FIG. 10, illustrated is an example of an end-to-end learned codec according to an example embodiment of the present disclosure. Features of FIG. 10 that are similar to FIG. 8 are referred to with the same reference numbers, and duplicative description is omitted.

In an example embodiment, the first signal, that is derived from the first set of features (812) and from the second set of features (836), may comprise an output of a neural network, such as a seventh set of layers (1010), that takes as input the first set of features (812) and the second set of features (836) and outputs the first signal.

In an example embodiment, the second signal, that is derived from the second set of features (836) and from an output (872) of the third decoder (864), may comprise an output of another neural network or a portion of another neural network, such as an eight set of layers (1020), that takes as input the second set of features (836) and an output (872) of the third decoder (864) and outputs the second signal.

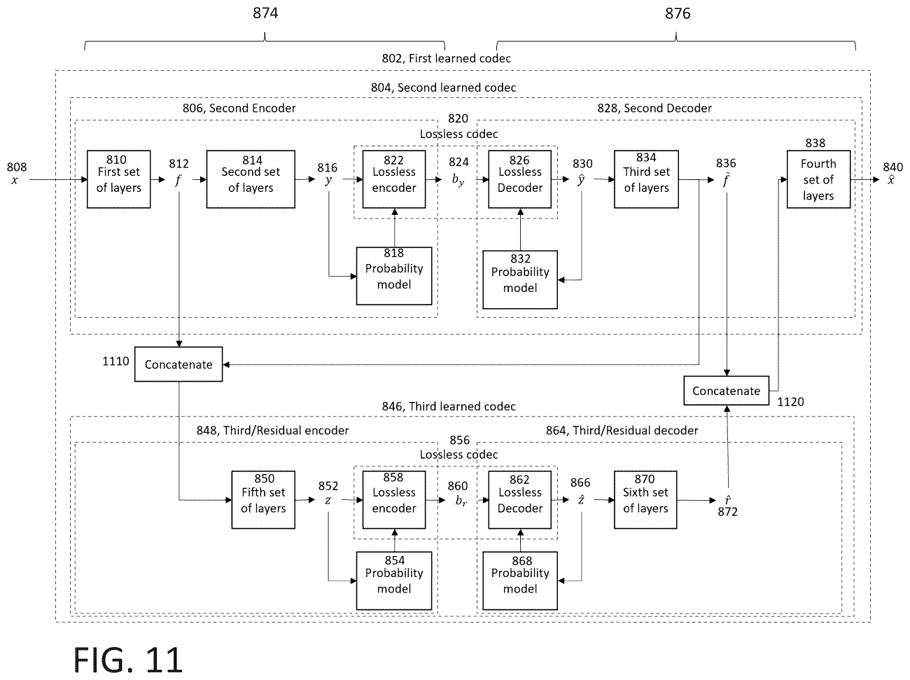

In an example embodiment, learned derivation of the residual may be performed by the third learned codec. Referring now to FIG. 11, illustrated is an example of an end-to-end learned codec according to an example embodiment of the present disclosure. Features of FIG. 11 that are similar to FIG. 8 are referred to with the same reference numbers, and duplicative description is omitted.

In an example embodiment, the first signal, that is derived from the first set of features (812) and from the second set of features (836), may comprise or be derived from a result of concatenating (1110) the first set of features (812) and the second set of features (836).

In an example embodiment, the second signal, that is derived from the second set of features (836) and from an output (872) of the third decoder (864), may comprise or be derived from a result of concatenating (1120) the second set of features (836) and an output (872) of the third decoder (864).

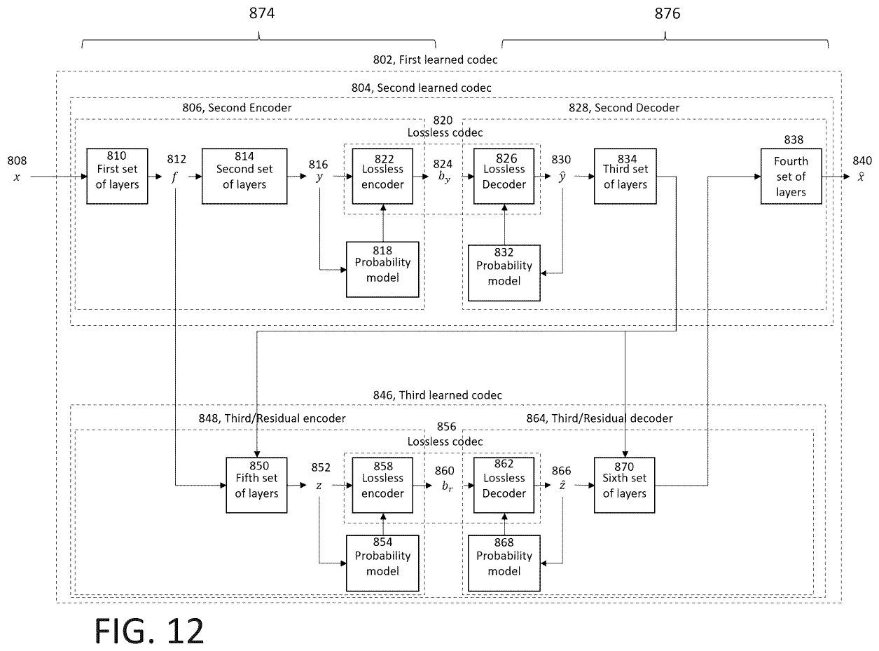

Referring now to FIG. 12, illustrated is an example of an end-to-end learned codec according to an example embodiment of the present disclosure. Features of FIG. 12 that are similar to FIG. 8 are referred to with the same reference numbers, and duplicative description is omitted. In an example embodiment, the first set of features (812) and the second set of features (836) may be provided to the third encoder (848) as two separate inputs. In an example embodiment, the second set of features (836) may be input to the residual decoder (864), and an output of the residual decoder may be input to the fourth set of layers (838).

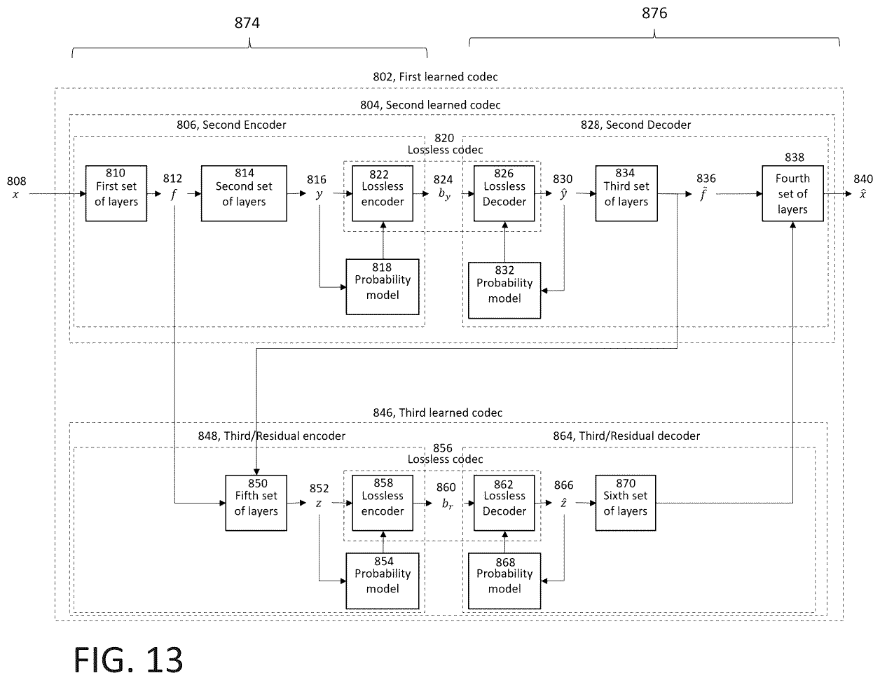

Referring now to FIG. 13, illustrated is an example of an end-to-end learned codec according to an example embodiment of the present disclosure. Features of FIG. 13 that are similar to FIGS. 8 and 12 are referred to with the same reference numbers, and duplicative description is omitted. In an example embodiment, the second set of features (836) and an output of the third decoder (864) may be provided to the fourth set of layers (838) as two separate inputs.

In an example embodiment, the residual encoder (848) may implicitly (e.g., based on learned information) compute a residual information based on the first set of features (812) and the second set of features (836), and encode that residual information.

In an example embodiment, the residual decoder (864) may implicitly (e.g., based on learned information) compensate or combine the second set of features (836) and a decoded residual information (866).

In an example embodiment, the fourth set of layers (838) may implicitly (e.g., based on learned information) compensate or combine the second set of features (836) and an output of the third decoder (872).

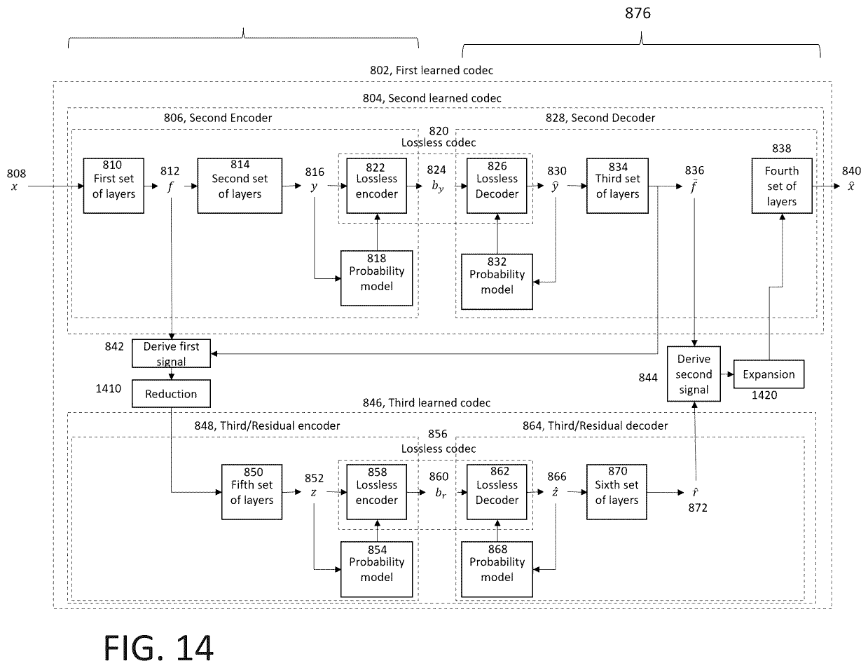

In an example embodiment, a residual derived for a reduced first signal may be coded. Referring now to FIG. 14, illustrated is an example of an end-to-end learned codec according to an example embodiment of the present disclosure. Features of FIG. 14 that are similar to FIG. 8 are referred to with the same reference numbers, and duplicative description is omitted.

A technical effect of example embodiments of the present disclosure associated with FIG. 14 may comprise (but may not be limited to) one or more of the following: reduction in complexity of the encoding and/or decoding process, reduction in the bitrate (size of the bitstream, or size of the encoded data), reduction in the distortion of the decoded data, reduction in memory used by the encoder and/or decoder process.

In an example embodiment, the first signal may be reduced by means of a reduction operation (1410), obtaining a reduced first signal, and the second signal may be expanded by means of an expansion operation (1420), obtaining an expanded second signal. The residual codec (846) may code a residual information that is derived from the reduced first signal. The expanded second signal may be input to the fourth set of layers (838).

In an example embodiment, the reduction operation (1410) may comprise decreasing a spatial resolution of the first signal, e.g., by performing a downsampling operation, for example with a downsampling factor of 2, and the expansion operation (1420) may comprise increasing a spatial resolution of the second signal, e.g., by performing an upsampling operation, for example with an upsampling factor of 2.

A downsampling or a downsampling operation may comprise (but may not be limited to) one or more of the following: a max-pooling neural network layer, an average pooling neural network layer, a global pooling neural network layer, a pixel unshuffle neural network layer, downsampling based on subpixel convolution (e.g., rearranging data from spatial dimension to depth or channel dimension), a convolutional neural network layer with a stride that is greater than 1 (may be also referred to as a strided convolutional layer), a convolutional neural network layer with a dilation rate that is greater than 1 (may be also referred to as a dilated convolutional layer), interpolation operation (e.g., by means of the nearest algorithm, or by means of the bilinear algorithm), a learned downsampling operation, a Fourier Transform based downsampling method.

An upsampling or an upsampling operation may comprise (but may not be limited to) one or more of the following: interpolation-based upsampling (e.g., based on bilinear interpolation, or bicubic interpolation, or nearest-neighbor interpolation), pixel shuffle neural network layer, upsampling subpixel convolution (e.g., rearranging data from depth or channel dimension to spatial dimension), transpose convolutional neural network layer (may be also referred to as fractionally strided convolution), a learned upsampling operation, a learned interpolation, unpooling, a Fourier Transform based upsampling operation.

In another example embodiment, the reduction operation (1310) may comprise decreasing the number of channels of a tensor representing the first signal. The expansion operation (1320) may comprise increasing the number of channels of a tensor representing the second signal. The decreasing and expansion operation may be performed by a linear projection, affine projection or convolution operation.

In an example embodiment, the first set of features (812) and the second set of features (836) may be reduced by means of a reduction operation, obtaining a reduced first set of features and a reduced second set of features, respectively. The reduced first set of features and the reduced second set of features may be used to derive (842) the first signal. The reduced second set of features and an output (872) of the residual decoder (864) may be used to derive (844) the second signal.

In an example embodiment, the reduction operation may be performed whereas the expansion operation (1420) may not be performed.

In an example embodiment, the first signal may be reduced by means of a reduction operation (1410), obtaining a reduced first signal. The second features (836) may be reduced by means of another reduction operation, to obtain reduced second features. The second signal may be derived (844) based on the reduced second features and on the output of the sixth set of layers (870). The second signal may be input to the fourth set of layers (838).

In an example embodiment, the first signal may be reduced by means of a reduction operation (1410), obtaining a reduced first signal. The output of the sixth set of layers (870) may be expanded by means of an expansion operation, obtaining an expanded output of the sixth set of layers. The second signal may be derived based on the second features and on the expanded output of the sixth set of layers. The second signal may be input to the fourth set of layers (838).

In the examples of FIGS. 8-15, reciprocal operations have been used to derive a first signal and derive a second signal. For example, in the example of FIG. 9, the first signal may be determined via subtraction, while the second signal may be determined via summation/addition. However, the example embodiments of the present disclosure are not limited to the use of reciprocal operations in the first encoder (874) and the first decoder (876) of the first learned codec (802). In an example embodiment, one type of operation may be used for obtaining a first signal, while another (non-reciprocal) type of operation may be used for obtaining a second signal. For example, subtraction (e.g. as illustrated in FIG. 9) may be used to obtain a first signal, while concatenation (e.g. as illustrated in FIG. 11) may be used to obtain a second signal. In another example, concatenation (e.g. as illustrated in FIG. 11) may be used to obtain a first signal, while summation (e.g. as illustrated in FIG. 9) may be used to obtain a second signal. In another example, subtraction (e.g. as illustrated in FIG. 9) may be used to obtain a first signal, while learned determination (e.g. as illustrated in FIG. 10) may be used to obtain a second signal. These examples are not limiting; other combinations of operations for obtaining each of the first signal and the second signal may be possible.

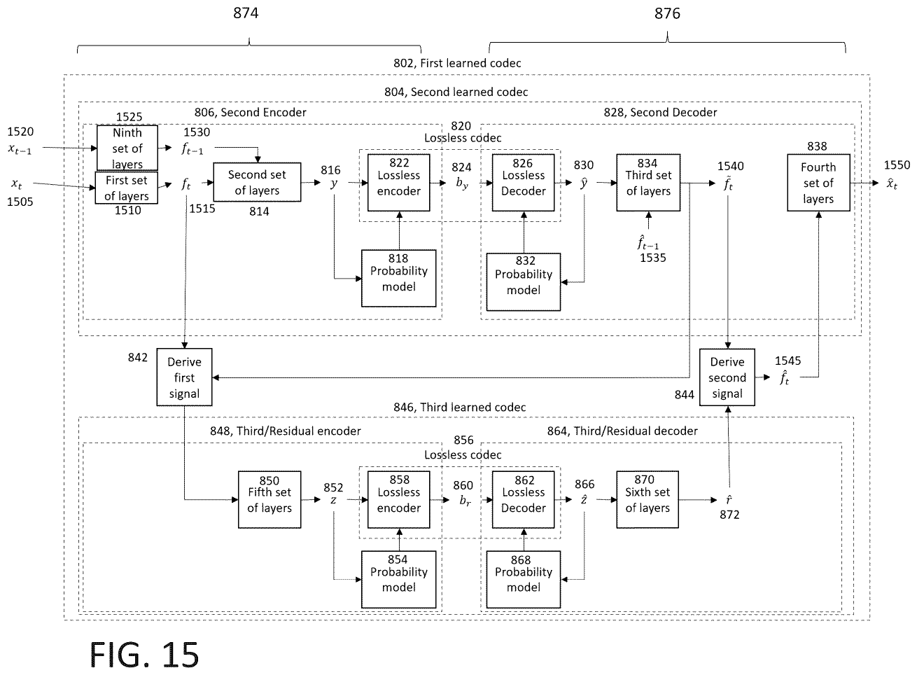

Example embodiments of the present disclosure may be extended to inter-frame coding. In an example embodiment, the first learned codec (802) may be extended to work as an inter-frame codec that may be part of a video codec, such as a learned video codec. Here, we describe the main differences with respect to the example embodiment illustrated in FIG. 8; any previous variations and embodiments may apply also to this extension to inter-frame coding. Referring now to FIG. 15, illustrated is an example of an end-to-end learned codec according to an example embodiment of the present disclosure. Features of FIG. 15 that are similar to FIG. 8 are referred to with the same reference numbers, and duplicative description is omitted.

In an example embodiment, an input to the encoder (874) of the first learned codec (802) and to the encoder (806) of the second learned codec (804) may be a current picture xₜ (1505) and a previous picture xₜ₋₁ (1520) that are comprised in a video, or a current picture xₜ (1505) and information derived from a previous picture xₜ₋₁ (1520), where the terms “current” and “previous” may refer to an output or display order, or to a coding order. The previous picture xₜ₋₁ (1520) may be retrieved from memory. The inter-frame codec may be run iteratively, e.g., once for every picture to be encoded and/or decoded. The current picture may be a picture to be encoded and/or decoded at the current iteration t. An output of the first decoder (876) and of the second decoder (828) may be a decoded current picture \hat{x}ₜ (1550).

A first set of layers (1510) may be used to extract the first set of features fₜ (1515) from the current picture xₜ (1505). A ninth set of layers (1525), which may be the same or substantially the same as the first set of layers (1510) or may be different from the first set of layers (1510), may be used to extract a third set of features fₜ₋₁ (1530) from the previous picture xₜ₋₁ (1520). Alternatively, the third set of features fₜ₋₁ (1530) may be retrieved from memory. Likewise, the first set of features fₜ (1515) may be stored in memory for use in coding future input. When, at the current iteration t, the third set of features fₜ₋₁ (1530) is retrieved from memory, the third set of features fₜ₋₁ (1530) may have been extracted at the previous iteration t-1 based on the first set of layers (1510) and stored in memory.

The first set of features (1515) and the third set of features (1530) may be input to the second set of layers (814). The second set of layers (814) may output a first latent tensor (816) that may then be quantized and lossless coded (822). In one example, the first latent tensor (816) may represent information about motion in feature domain, e.g., a motion between pictures xₜ (1505) and xₜ₋₁ (1520), or a motion between the first set of features (1515) and the third set of features (1530).

The first set of features (1515) and the second set of features (1540) may be used to derive (842) the first signal as in previous embodiments.

The second signal \hat{f}ₜ, that is derived from an output (872) of the third decoder (864) and from the second set of features (1540), may represent reconstructed and residual-compensated features of the current frame. In a previous iteration t-1, when the picture to be coded was xₜ₋₁ (1520), the respective second signal may also be referred to as a previous second signal, \hat{f}ₜ₋₁ (1535). In other words, the previous second signal, \hat{f}ₜ₋₁ (1535), may comprise or may be derived from the second signal obtained when coding a previous picture xₜ₋₁. In an example embodiment, the previous second signal, \hat{f}ₜ₋₁ (1535), may comprise a signal determined during coding of the picture xₜ₋₁ (1520) based on: a set of features determined for xₜ₋₁ (1520) based on a decoded latent tensor associated with xₜ₋₁ (1520); and decoded residual information associated with xₜ₋₁ (1520).

When coding the current picture xₜ (1505), the previous second signal \hat{f}ₜ₋₁ (1535) obtained when coding the previous picture xₜ₋₁ (1520), or data derived from the previous second signal \hat{f}ₜ₋₁ (1535), may be input to the third set of layers (834), together with a lossless decoded and dequantized latent tensor (830). The third set of layers (834) may comprise performing motion compensation in the feature domain of the previous second signal (1535), either in an explicit manner or in an implicit (e.g., based on learned information) manner. In one example, the second signal \hat{f}ₜ₋₁ (1535) obtained when coding the previous picture xₜ₋₁ (1520) may be motion-compensated or warped based at least on the lossless decoded and dequantized latent tensor (830) that may represent motion information in feature domain.

In an example embodiment, \hat{f}ₜ₋₁ may be retrieved from memory. Likewise, \hat{f}ₜ may be stored in memory for use in coding future input.

The second learned codec (804) may be referred to as a feature-domain motion codec, e.g., a codec that encodes and/or decodes motion information in feature domain. The bitstream by (824) may represent encoded motion information.

In one example embodiment, in addition to the current picture, more than one previously-coded picture and/or information derived from more than one previously-coded picture may be used as an input to the first learned codec. For example, when coding a current picture, an input to the first learned codec may comprise the current picture and two previously-coded pictures (or the current picture and information derived from two previously-coded pictures), where the two previously-coded pictures may comprise a first previously-coded picture that has an output or display time that is before the output or display time of the current picture (e.g., a past picture in output or display order) and a second previously-coded picture that has an output or display time that is after the output or display time of the current picture (e.g., a future picture in output or display order). In the second encoder, features from the more than one previously-coded picture may be extracted and input to the second set of layers (814) together with features (1515) extracted from the current picture. In the second decoder, the third set of layers (834) may get, as input, the lossless decoded and dequantized latent tensor (830) and more than one second signal obtained when coding the respective more than one previous picture.

In one example embodiment, the second features (836) output by the third set of layers (834), or data derived from the second features (836) output by the third set of layers (834), may be input to one or more of the following: the fifth set of layers (850), the probability model (854) of the third encoder (848), the probability model (868) of the third decoder (864), and/or the sixth set of layers (870).

In one example embodiment, the lossless decoded and dequantized latent tensor (830), or data derived from the lossless decoded and dequantized latent tensor (830), may be input to one or more of the following: the fifth set of layers (850), the probability model (854) of the third encoder (848), the probability model (868) of the third decoder (864), and/or the sixth set of layers (870).

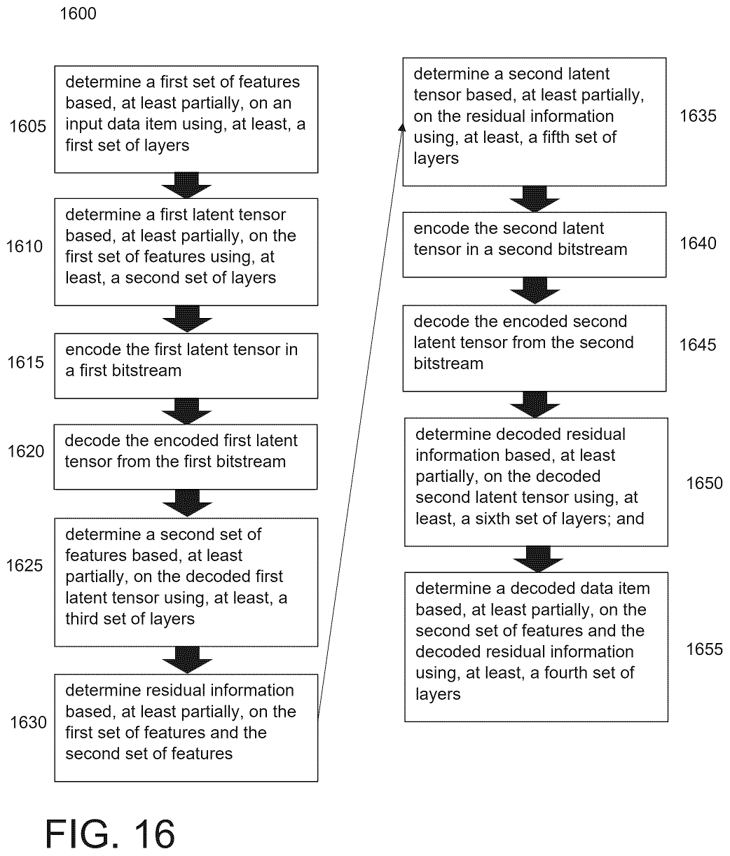

FIG. 16 illustrates the potential steps of an example method 1600. The example method 1600 may include: determining a first set of features based, at least partially, on an input data item using, at least, a first set of layers, 1605; determining a first latent tensor based, at least partially, on the first set of features using, at least, a second set of layers, 1610; encoding the first latent tensor in a first bitstream, 1615; decoding the encoded first latent tensor from the first bitstream, 1620; determining a second set of features based, at least partially, on the decoded first latent tensor using, at least, a third set of layers, 1625; determining residual information based, at least partially, on the first set of features and the second set of features, 1630; determining a second latent tensor based, at least partially, on the residual information using, at least, a fifth set of layers, 1635; encoding the second latent tensor in a second bitstream, 1640; decoding the encoded second latent tensor from the second bitstream, 1645; determining decoded residual information based, at least partially, on the decoded second latent tensor using, at least, a sixth set of layers, 1650; and determining a decoded data item based, at least partially, on the second set of features and the decoded residual information using, at least, a fourth set of layers, 1655. The example method 1600 may be performed, for example, with a codec, a learned codec, an end-to-end learned codec, etc.

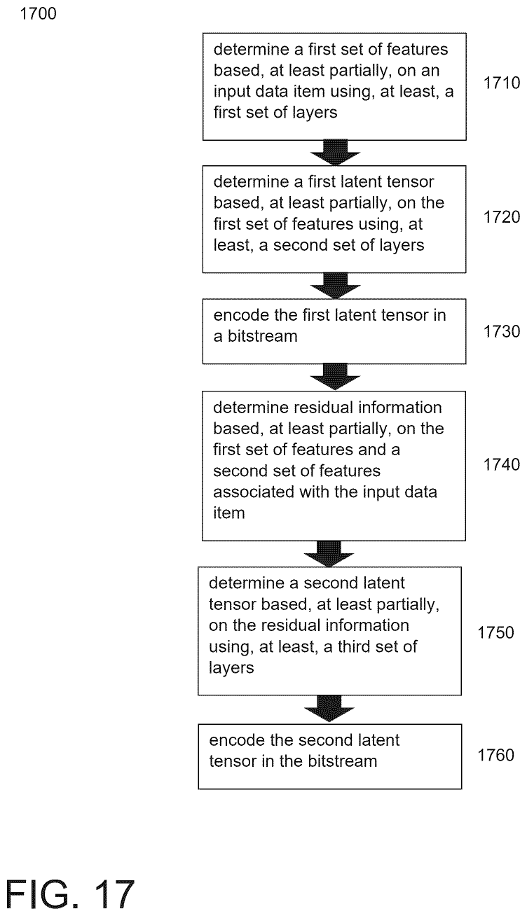

FIG. 17 illustrates the potential steps of an example method 1700. The example method 1700 may include: determining a first set of features based, at least partially, on an input data item using, at least, a first set of layers, 1710; determining a first latent tensor based, at least partially, on the first set of features using, at least, a second set of layers, 1720; encoding the first latent tensor in a bitstream, 1730; determining residual information based, at least partially, on the first set of features and a second set of features associated with the input data item, 1740; determining a second latent tensor based, at least partially, on the residual information using, at least, a third set of layers, 1750; and encoding the second latent tensor in the bitstream, 1760. The example method 1700 may be performed, for example, with an encoder, a learned encoder, an end-to-end learned encoder, a codec, etc.

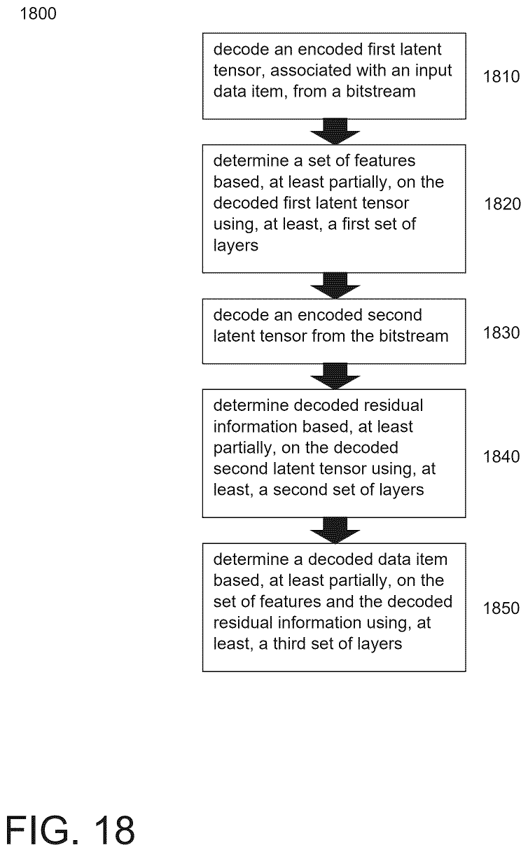

FIG. 18 illustrates the potential steps of an example method 1800. The example method 1800 may include: decoding an encoded first latent tensor, associated with an input data item, from a bitstream, 1810; determining a set of features based, at least partially, on the decoded first latent tensor using, at least, a first set of layers, 1820; decoding an encoded second latent tensor from the bitstream, 1830; determining decoded residual information based, at least partially, on the decoded second latent tensor using, at least, a second set of layers, 1840; and determining a decoded data item based, at least partially, on the set of features and the decoded residual information using, at least, a third set of layers, 1850. The example method 1800 may be performed, for example, with a decoder, a learned decoder, an end-to-end learned decoder, a codec, etc.

In accordance with one example embodiment, an apparatus may comprise: at least one processor; and at least one memory storing instructions that, when executed by the at least one processor, cause the apparatus at least to: determine a first set of features based, at least partially, on an input data item using, at least, a first set of layers; determine a first latent tensor based, at least partially, on the first set of features using, at least, a second set of layers; encode the first latent tensor in a first bitstream; decode the encoded first latent tensor from the first bitstream; determine a second set of features based, at least partially, on the decoded first latent tensor using, at least, a third set of layers; determine residual information based, at least partially, on the first set of features and the second set of features; determine a second latent tensor based, at least partially, on the residual information using, at least, a fifth set of layers; encode the second latent tensor in a second bitstream; decode the encoded second latent tensor from the second bitstream; determine decoded residual information based, at least partially, on the decoded second latent tensor using, at least, a sixth set of layers; and determine a decoded data item based, at least partially, on the second set of features and the decoded residual information using, at least, a fourth set of layers.

The residual information may comprise residual information in a feature domain.

Determining the residual information may comprise the example apparatus being further configured to: determine at least one first signal based, at least partially, on the first set of features and the second set of features; and provide the at least one first signal to the fifth set of layers.

Determining the decoded data item may comprise the example apparatus being further configured to: determine at least one second signal based, at least partially, on the second set of features and the decoded residual information; and determine the decoded data item based, at least partially, on the at least one second signal using the fourth set of layers.

Determining the residual information may comprise the example apparatus being further configured to: determine a difference between the first set of features and the second set of features.

The difference between the first set of features and the second set of features may comprise an element-wise subtraction between the first set of features and the second set of features.

Determining the decoded data item may comprise the example apparatus being further configured to: sum the second set of features and the decoded residual information; and determine the decoded data item based, at least partially, on the summed second set of features and decoded residual information using the fourth set of layers.

The summed second set of features and decoded residual information may comprise an element-wise addition of the second set of features and the decoded residual information.

The residual information may be determined using a seventh set of layers.

Determining the decoded data item may comprise the example apparatus being further configured to: refine the second set of features based, at least partially, on the decoded residual information using an eighth set of layers; and determine the decoded data item based, at least partially, on the refined second set of features using the fourth set of layers.

Determining the residual information may comprise the example apparatus being further configured to: concatenate the first set of features and the second set of features.

Determining the decoded data item may comprise the example apparatus being further configured to: concatenate the second set of features and the decoded residual information; and determine the decoded data item based, at least partially, on the concatenated second set of features and decoded residual information using the fourth set of layers.

Determining the residual information may comprise the example apparatus being further configured to: provide the first set of features and the second set of features to the fifth set of layers.

Determining the decoded data item may comprise the example apparatus being further configured to: provide the second set of features to the sixth set of layers; and provide an output of the sixth set of layers to the fourth set of layers.

Determining the decoded data item may comprise the example apparatus being further configured to: provide the second set of features and the decoded residual information to the fourth set of layers.

The example apparatus may be further configured to: reduce the residual information; and determine the second latent tensor based, at least partially, on the reduced residual information.

Reducing the residual information may comprise the example apparatus being further configured to at least one of: decrease a spatial resolution of the residual information; and/or decrease a number of channels representing the residual information.

The example apparatus may be further configured to: expand at least one signal, wherein the at least one signal may be based, at least partially, on the decoded residual information; and provide the at least one expanded signal to the fourth set of layers.

Expanding the at least one signal may comprise the example apparatus being further configured to at least one of: increase a spatial resolution of the at least one signal; and/or increase a number of channels representing the at least one signal.

The at least one signal may be further based on the second set of features.

The residual information may be determined based, at least partially, on a reduced version of the first set of features and a reduced version of the second set of features, wherein the decoded data item may be determined based, at least partially, on the reduced version of the second set of features and the decoded residual information.

Determining the decoded data item may comprise the example apparatus being further configured to: expand the decoded residual information; determine at least one signal based, at least partially, on the second set of features and the expanded decoded residual information; and determine the decoded data item based, at least partially, on the at least one determined signal using, at least, the fourth set of layers.

The input data item may comprise a current picture, and the example apparatus may be further configured to: determine a third set of features based, at least partially, on at least one previous picture using a further set of layers, wherein the first latent tensor may be further determined based on the third set of features; and determine a fourth set of features based, at least partially, on the at least one previous picture, wherein the second set of features may be further determined based on the fourth set of features.

The current picture may comprise a current picture in one of: an output order of a plurality of pictures, a display order of the plurality of pictures, or a coding order of the plurality of pictures.

The first set of layers and the further set of layers may be, at least, substantially similar.

The first latent tensor may comprise, at least, motion information in a feature domain.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The fourth set of features may comprise at least one signal determined during coding of the at least one previous picture based, at least partially, on: a set of features determined for the at least one previous picture based on a decoded latent tensor associated with the at least one previous picture, and decoded residual information associated with the at least one previous picture.

The input data item may comprise at least one of: visual data, an image, a portion of the image, a video frame, a portion of the video frame, or audio information.

The example apparatus may comprise at least one of: an end-to-end learned codec, an intra-frame codec, an inter-frame codec, a video codec, or an image codec.

The second set of features may comprise an initial reconstruction of the first set of features of the input data item.

Determining the decoded data item may comprise the example apparatus being configured to: for at least part of the input data item, determine at least part of the decoded data item based on at least part of the second set of features and not the decoded residual information.

At least one of: the second latent tensor, or the decoded residual information may be determined further based on the second set of features.

At least one of: the second latent tensor, or the decoded residual information may be determined further based on the decoded first latent tensor.

Determining the residual information may comprise the example apparatus being configured to: for at least part of the input data item, determine at least part of the residual information based, at least partially, on the first set of features and a set of features determined based on a previously coded part of the input data item.

Determining the decoded data item may comprise the example apparatus being configured to: for at least part of the input data item, determine at least part of the decoded data item based, at least partially, on a set of features of a previously coded part of the input data item and the decoded residual information.

The example apparatus may be further configured to: include, in the first bitstream, an indication that, for at least part of the input data item, the decoded data item is to be determined without using at least one of: the sixth set of layers, or the decoded residual information.

The example apparatus may be further configured to: include, in the first bitstream, an indication that, for at least part of the input data item, the decoded data item is to be determined without using at least one of: the third set of layers, or the second set of features.

In accordance with one embodiment, an example method may be provided comprising: determining, with a codec, a first set of features based, at least partially, on an input data item using, at least, a first set of layers; determining a first latent tensor based, at least partially, on the first set of features using, at least, a second set of layers; encoding the first latent tensor in a first bitstream; decoding the encoded first latent tensor from the first bitstream; determining a second set of features based, at least partially, on the decoded first latent tensor using, at least, a third set of layers; determining residual information based, at least partially, on the first set of features and the second set of features; determining a second latent tensor based, at least partially, on the residual information using, at least, a fifth set of layers; encoding the second latent tensor in a second bitstream; decoding the encoded second latent tensor from the second bitstream; determining decoded residual information based, at least partially, on the decoded second latent tensor using, at least, a sixth set of layers; and determining a decoded data item based, at least partially, on the second set of features and the decoded residual information using, at least, a fourth set of layers.

The residual information may comprise residual information in a feature domain.

The determining of the residual information may comprise: determining at least one first signal based, at least partially, on the first set of features and the second set of features; and providing the at least one first signal to the fifth set of layers.

The determining of the decoded data item may comprise: determining at least one second signal based, at least partially, on the second set of features and the decoded residual information; and determining the decoded data item based, at least partially, on the at least one second signal using the fourth set of layers.

The determining of the residual information may comprise: determining a difference between the first set of features and the second set of features.

The difference between the first set of features and the second set of features may comprise an element-wise subtraction between the first set of features and the second set of features.

The determining of the decoded data item may comprise: summing the second set of features and the decoded residual information; and determining the decoded data item based, at least partially, on the summed second set of features and decoded residual information using the fourth set of layers.

The summed second set of features and decoded residual information may comprise an element-wise addition of the second set of features and the decoded residual information.

The residual information may be determined using a seventh set of layers.

The determining of the decoded data item may comprise: refining the second set of features based, at least partially, on the decoded residual information using an eighth set of layers; and determining the decoded data item based, at least partially, on the refined second set of features using the fourth set of layers.

The determining of the residual information may comprise: concatenating the first set of features and the second set of features.

The determining of the decoded data item may comprise: concatenating the second set of features and the decoded residual information; and determining the decoded data item based, at least partially, on the concatenated second set of features and decoded residual information using the fourth set of layers.

The determining of the residual information may comprise: providing the first set of features and the second set of features to the fifth set of layers.

The determining of the decoded data item may comprise: providing the second set of features to the sixth set of layers; and providing an output of the sixth set of layers to the fourth set of layers.

The determining of the decoded data item may comprise: providing the second set of features and the decoded residual information to the fourth set of layers.

The example method may further comprise: reducing the residual information; and determining the second latent tensor based, at least partially, on the reduced residual information.

The reducing of the residual information may comprise at least one of: decreasing a spatial resolution of the residual information; and/or decreasing a number of channels representing the residual information.

The example method may further comprise: expanding at least one signal, wherein the at least one signal may be based, at least partially, on the decoded residual information; and providing the at least one expanded signal to the fourth set of layers.

The expanding of the at least one signal may comprise at least one of: increasing a spatial resolution of the at least one signal; and/or increasing a number of channels representing the at least one signal.

The at least one signal may be further based on the second set of features.

The residual information may be determined based, at least partially, on a reduced version of the first set of features and a reduced version of the second set of features, wherein the decoded data item may be determined based, at least partially, on the reduced version of the second set of features and the decoded residual information.

The determining of the decoded data item may comprise: expanding the decoded residual information; determining at least one signal based, at least partially, on the second set of features and the expanded decoded residual information; and determining the decoded data item based, at least partially, on the at least one determined signal using, at least, the fourth set of layers.

The input data item may comprise a current picture, and the example method may further comprise: determining a third set of features based, at least partially, on at least one previous picture using a further set of layers, wherein the first latent tensor may be further determined based on the third set of features; and determining a fourth set of features based, at least partially, on the at least one previous picture, wherein the second set of features may be further determined based on the fourth set of features.

The current picture may comprise a current picture in one of: an output order of a plurality of pictures, a display order of the plurality of pictures, or a coding order of the plurality of pictures.

The first set of layers and the further set of layers may be, at least, substantially similar.

The first latent tensor may comprise, at least, motion information in a feature domain.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The fourth set of features may comprise at least one signal determined during coding of the at least one previous picture based, at least partially, on: a set of features determined for the at least one previous picture based on a decoded latent tensor associated with the at least one previous picture, and decoded residual information associated with the at least one previous picture.

The input data item may comprise at least one of: visual data, an image, a portion of the image, a video frame, a portion of the video frame, or audio information.

The codec may comprise at least one of: an end-to-end learned codec, an intra-frame codec, an inter-frame codec, a video codec, or an image codec.

The second set of features may comprise an initial reconstruction of the first set of features of the input data item.

The determining of the decoded data item may comprise: for at least part of the input data item, determining at least part of the decoded data item based on at least part of the second set of features and not the decoded residual information.

At least one of: the second latent tensor, or the decoded residual information may be determined further based on the second set of features.

At least one of: the second latent tensor, or the decoded residual information may be determined further based on the decoded first latent tensor.

The determining of the residual information may comprise: for at least part of the input data item, determining at least part of the residual information based, at least partially, on the first set of features and a set of features determined based on a previously coded part of the input data item.

The determining of the decoded data item may comprise: for at least part of the input data item, determining at least part of the decoded data item based, at least partially, on a set of features of a previously coded part of the input data item and the decoded residual information.

The example method may further comprise: including, in the first bitstream, an indication that, for at least part of the input data item, the decoded data item is to be determined without using at least one of: the sixth set of layers, or the decoded residual information.

The example method may further comprise: include, in the first bitstream, an indication that, for at least part of the input data item, the decoded data item is to be determined without using at least one of: the third set of layers, or the second set of features.

In accordance with one example embodiment, an apparatus may comprise: circuitry configured to perform: determining, with a codec, a first set of features based, at least partially, on an input data item using, at least, a first set of layers; circuitry configured to perform: determining a first latent tensor based, at least partially, on the first set of features using, at least, a second set of layers; circuitry configured to perform: encoding the first latent tensor in a first bitstream; circuitry configured to perform: decoding the encoded first latent tensor from the first bitstream; circuitry configured to perform: determining a second set of features based, at least partially, on the decoded first latent tensor using, at least, a third set of layers; circuitry configured to perform: determining residual information based, at least partially, on the first set of features and the second set of features; circuitry configured to perform: determining a second latent tensor based, at least partially, on the residual information using, at least, a fifth set of layers; circuitry configured to perform: encoding the second latent tensor in a second bitstream; circuitry configured to perform: decoding the encoded second latent tensor from the second bitstream; circuitry configured to perform: determining decoded residual information based, at least partially, on the decoded second latent tensor using, at least, a sixth set of layers; and circuitry configured to perform: determining a decoded data item based, at least partially, on the second set of features and the decoded residual information using, at least, a fourth set of layers.

In accordance with one example embodiment, an apparatus may comprise: processing circuitry; memory circuitry including computer program code, the memory circuitry and the computer program code configured to, with the processing circuitry, enable the apparatus to: determine a first set of features based, at least partially, on an input data item using, at least, a first set of layers; determine a first latent tensor based, at least partially, on the first set of features using, at least, a second set of layers; encode the first latent tensor in a first bitstream; decode the encoded first latent tensor from the first bitstream; determine a second set of features based, at least partially, on the decoded first latent tensor using, at least, a third set of layers; determine residual information based, at least partially, on the first set of features and the second set of features; determine a second latent tensor based, at least partially, on the residual information using, at least, a fifth set of layers; encode the second latent tensor in a second bitstream; decode the encoded second latent tensor from the second bitstream; determine decoded residual information based, at least partially, on the decoded second latent tensor using, at least, a sixth set of layers; and determine a decoded data item based, at least partially, on the second set of features and the decoded residual information using, at least, a fourth set of layers.

As used in this application, the term “circuitry” or “means” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or such as processor(s), a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: determining a first set of features based, at least partially, on an input data item using, at least, a first set of layers; determining a first latent tensor based, at least partially, on the first set of features using, at least, a second set of layers; encoding the first latent tensor in a first bitstream; decoding the encoded first latent tensor from the first bitstream; determining a second set of features based, at least partially, on the decoded first latent tensor using, at least, a third set of layers; determining residual information based, at least partially, on the first set of features and the second set of features; determining a second latent tensor based, at least partially, on the residual information using, at least, a fifth set of layers; encoding the second latent tensor in a second bitstream; decoding the encoded second latent tensor from the second bitstream; determining decoded residual information based, at least partially, on the decoded second latent tensor using, at least, a sixth set of layers; and determining a decoded data item based, at least partially, on the second set of features and the decoded residual information using, at least, a fourth set of layers.

The residual information may comprise residual information in a feature domain.

The means configured for determining the residual information may comprise means configured for: determining at least one first signal based, at least partially, on the first set of features and the second set of features; and providing the at least one first signal to the fifth set of layers.

The means configured for determining the decoded data item may comprise means configured for: determining at least one second signal based, at least partially, on the second set of features and the decoded residual information; and determining the decoded data item based, at least partially, on the at least one second signal using the fourth set of layers.

The means configured for determining the residual information may comprise means configured for: determining a difference between the first set of features and the second set of features.

The difference between the first set of features and the second set of features may comprise an element-wise subtraction between the first set of features and the second set of features.

The means configured for determining the decoded data item may comprise means configured for: summing the second set of features and the decoded residual information; and determining the decoded data item based, at least partially, on the summed second set of features and decoded residual information using the fourth set of layers.

The summed second set of features and decoded residual information may comprise an element-wise addition of the second set of features and the decoded residual information.

The residual information may be determined using a seventh set of layers.

The means configured for determining the decoded data item may comprise means configured for: refining the second set of features based, at least partially, on the decoded residual information using an eighth set of layers; and determining the decoded data item based, at least partially, on the refined second set of features using the fourth set of layers.

The means configured for determining the residual information may comprise means configured for: concatenating the first set of features and the second set of features.

The means configured for determining the decoded data item may comprise means configured for: concatenating the second set of features and the decoded residual information; and determining the decoded data item based, at least partially, on the concatenated second set of features and decoded residual information using the fourth set of layers.

The means configured for determining the residual information may comprise means configured for: providing the first set of features and the second set of features to the fifth set of layers.

The means configured for determining the decoded data item may comprise means configured for: providing the second set of features to the sixth set of layers; and providing an output of the sixth set of layers to the fourth set of layers.

The means configured for determining the decoded data item may comprise means configured for: providing the second set of features and the decoded residual information to the fourth set of layers.

The means may be further configured for: reducing the residual information; and determining the second latent tensor based, at least partially, on the reduced residual information.

The means configured for reducing the residual information may comprise means configured for at least one of: decreasing a spatial resolution of the residual information; and/or decreasing a number of channels representing the residual information.

The means may be further configured for: expanding at least one signal, wherein the at least one signal may be based, at least partially, on the decoded residual information; and providing the at least one expanded signal to the fourth set of layers.

The means configured for expanding the at least one signal may comprise means configured for at least one of: increasing a spatial resolution of the at least one signal; and/or increasing a number of channels representing the at least one signal.

The at least one signal may be further based on the second set of features.

The residual information may be determined based, at least partially, on a reduced version of the first set of features and a reduced version of the second set of features, wherein the decoded data item may be determined based, at least partially, on the reduced version of the second set of features and the decoded residual information.

The means configured for determining the decoded data item may comprise means configured for: expanding the decoded residual information; determining at least one signal based, at least partially, on the second set of features and the expanded decoded residual information; and determining the decoded data item based, at least partially, on the at least one determined signal using, at least, the fourth set of layers.

The input data item may comprise a current picture, wherein the means may be further configured for: determining a third set of features based, at least partially, on at least one previous picture using a further set of layers, wherein the first latent tensor may be further determined based on the third set of features; and determining a fourth set of features based, at least partially, on the at least one previous picture, wherein the second set of features may be further determined based on the fourth set of features.

The current picture may comprise a current picture in one of: an output order of a plurality of pictures, a display order of the plurality of pictures, or a coding order of the plurality of pictures.

The first set of layers and the further set of layers may be, at least, substantially similar.

The first latent tensor may comprise, at least, motion information in a feature domain.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The fourth set of features may comprise at least one signal determined during coding of the at least one previous picture based, at least partially, on: a set of features determined for the at least one previous picture based on a decoded latent tensor associated with the at least one previous picture, and decoded residual information associated with the at least one previous picture.

The input data item may comprise at least one of: visual data, an image, a portion of the image, a video frame, a portion of the video frame, or audio information.

The example apparatus may comprise at least one of: an end-to-end learned codec, an intra-frame codec, an inter-frame codec, a video codec, or an image codec.

The second set of features may comprise an initial reconstruction of the first set of features of the input data item.

The means configured for determining the decoded data item may comprise means configured for: for at least part of the input data item, determining at least part of the decoded data item based on at least part of the second set of features and not the decoded residual information.

At least one of: the second latent tensor, or the decoded residual information may be determined further based on the second set of features.

At least one of: the second latent tensor, or the decoded residual information may be determined further based on the decoded first latent tensor.

The means configured for determining the residual information may comprise means configured for: for at least part of the input data item, determining at least part of the residual information based, at least partially, on the first set of features and a set of features determined based on a previously coded part of the input data item.

The means configured for determining the decoded data item may comprise means configured for: for at least part of the input data item, determining at least part of the decoded data item based, at least partially, on a set of features of a previously coded part of the input data item and the decoded residual information.

The means may be further configured for: including, in the first bitstream, an indication that, for at least part of the input data item, the decoded data item is to be determined without using at least one of: the sixth set of layers, or the decoded residual information.

The may be further configured for: including, in the first bitstream, an indication that, for at least part of the input data item, the decoded data item is to be determined without using at least one of: the third set of layers, or the second set of features.

A processor, memory, and/or example algorithms (which may be encoded as instructions, program, or code) may be provided as example means for providing or causing performance of operation.

In accordance with one example embodiment, a (non-transitory) computer-readable medium comprising instructions stored thereon which, when executed with at least one processor, cause the at least one processor to: determine, with a codec, a first set of features based, at least partially, on an input data item using, at least, a first set of layers; determine a first latent tensor based, at least partially, on the first set of features using, at least, a second set of layers; encode the first latent tensor in a first bitstream; decode the encoded first latent tensor from the first bitstream; determine a second set of features based, at least partially, on the decoded first latent tensor using, at least, a third set of layers; determine residual information based, at least partially, on the first set of features and the second set of features; determine a second latent tensor based, at least partially, on the residual information using, at least, a fifth set of layers; encode the second latent tensor in a second bitstream; decode the encoded second latent tensor from the second bitstream; determine decoded residual information based, at least partially, on the decoded second latent tensor using, at least, a sixth set of layers; and determine a decoded data item based, at least partially, on the second set of features and the decoded residual information using, at least, a fourth set of layers.

In accordance with one example embodiment, a (non-transitory) computer-readable medium comprising program instructions stored thereon for performing at least the following: determining, with a codec, a first set of features based, at least partially, on an input data item using, at least, a first set of layers; determining a first latent tensor based, at least partially, on the first set of features using, at least, a second set of layers; encoding the first latent tensor in a first bitstream; decoding the encoded first latent tensor from the first bitstream; determining a second set of features based, at least partially, on the decoded first latent tensor using, at least, a third set of layers; determining residual information based, at least partially, on the first set of features and the second set of features; determining a second latent tensor based, at least partially, on the residual information using, at least, a fifth set of layers; encoding the second latent tensor in a second bitstream; decoding the encoded second latent tensor from the second bitstream; determining decoded residual information based, at least partially, on the decoded second latent tensor using, at least, a sixth set of layers; and determining a decoded data item based, at least partially, on the second set of features and the decoded residual information using, at least, a fourth set of layers.

The residual information may comprise residual information in a feature domain.

The program instructions for performing determining the residual information may comprise program instructions for performing: determining at least one first signal based, at least partially, on the first set of features and the second set of features; and causing providing of the at least one first signal to the fifth set of layers.

The program instructions for performing determining the decoded data item may comprise program instructions for performing: determining at least one second signal based, at least partially, on the second set of features and the decoded residual information; and determining the decoded data item based, at least partially, on the at least one second signal using the fourth set of layers.

The program instructions for performing determining the residual information may comprise program instructions for performing: determining a difference between the first set of features and the second set of features.

The difference between the first set of features and the second set of features may comprise an element-wise subtraction between the first set of features and the second set of features.

The program instructions for performing determining the decoded data item may comprise program instructions for performing: summing the second set of features and the decoded residual information; and determining the decoded data item based, at least partially, on the summed second set of features and decoded residual information using the fourth set of layers.

The summed second set of features and decoded residual information may comprise an element-wise addition of the second set of features and the decoded residual information.

The residual information may be determined using a seventh set of layers.

The program instructions for performing determining the decoded data item may comprise program instructions for performing: refining the second set of features based, at least partially, on the decoded residual information using an eighth set of layers; and determining the decoded data item based, at least partially, on the refined second set of features using the fourth set of layers.

The program instructions for performing determining the residual information may comprise program instructions for performing: concatenating the first set of features and the second set of features.

The program instructions for performing determining the decoded data item may comprise program instructions for performing: concatenating the second set of features and the decoded residual information; and determining the decoded data item based, at least partially, on the concatenated second set of features and decoded residual information using the fourth set of layers.

The program instructions for performing determining the residual information may comprise program instructions for performing: causing providing of the first set of features and the second set of features to the fifth set of layers.

The program instructions for performing determining the decoded data item may comprise program instructions for performing: causing providing of the second set of features to the sixth set of layers; and causing providing of an output of the sixth set of layers to the fourth set of layers.

The program instructions for performing determining the decoded data item may comprise program instructions for performing: causing providing of the second set of features and the decoded residual information to the fourth set of layers.

The example computer-readable medium may be further configured for performing: reducing the residual information; and determining the second latent tensor based, at least partially, on the reduced residual information.

The program instructions for performing reducing the residual information may comprise program instructions for performing at least one of: decreasing a spatial resolution of the residual information; and/or decreasing a number of channels representing the residual information.

The example computer-readable medium may be further configured for performing: expanding at least one signal, wherein the at least one signal may be based, at least partially, on the decoded residual information; and causing providing of the at least one expanded signal to the fourth set of layers.

The program instructions for performing expanding the at least one signal may comprise program instructions for performing at least one of: increasing a spatial resolution of the at least one signal; and/or increasing a number of channels representing the at least one signal.

The at least one signal may be further based on the second set of features.

The residual information may be determined based, at least partially, on a reduced version of the first set of features and a reduced version of the second set of features, wherein the decoded data item may be determined based, at least partially, on the reduced version of the second set of features and the decoded residual information.

The program instructions for performing determining the decoded data instructions for item may comprise program performing: expanding the decoded residual information; determining at least one signal based, at least partially, on the second set of features and the expanded decoded residual information; and determining the decoded data item based, at least partially, on the at least one determined signal using, at least, the fourth set of layers.

The input data item may comprise a current picture, and the example computer-readable medium may be further configured to perform: determining a third set of features based, at least partially, on at least one previous picture using a further set of layers, wherein the first latent tensor may be further determined based on the third set of features; and determining a fourth set of features based, at least partially, on the at least one previous picture, wherein the second set of features may be further determined based on the fourth set of features.

The current picture may comprise a current picture in one of: an output order of a plurality of pictures, a display order of the plurality of pictures, or a coding order of the plurality of pictures.

The first set of layers and the further set of layers may be, at least, substantially similar.

The first latent tensor may comprise, at least, motion information in a feature domain.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The fourth set of features may comprise at least one signal determined during coding of the at least one previous picture based, at least partially, on: a set of features determined for the at least one previous picture based on a decoded latent tensor associated with the at least one previous picture, and decoded residual information associated with the at least one previous picture.

The input data item may comprise at least one of: visual data, an image, a portion of the image, a video frame, a portion of the video frame, or audio information.

The codec may comprise at least one of: an end-to-end learned codec, an intra-frame codec, an inter-frame codec, a video codec, or an image codec.

The second set of features may comprise an initial reconstruction of the first set of features of the input data item.

The program instructions for performing determining the decoded data item may comprise program instructions for performing: for at least part of the input data item, determining at least part of the decoded data item based on at least part of the second set of features and not the decoded residual information.

At least one of: the second latent tensor, or the decoded residual information may be determined further based on the second set of features.

At least one of: the second latent tensor, or the decoded residual information may be determined further based on the decoded first latent tensor.

The program instructions for performing determining the residual information may comprise program instructions for performing: for at least part of the input data item, determining at least part of the residual information based, at least partially, on the first set of features and a set of features determined based on a previously coded part of the input data item.

The program instructions for performing determining the decoded data item may comprise program instructions for performing: for at least part of the input data item, determining at least part of the decoded data item based, at least partially, on a set of features of a previously coded part of the input data item and the decoded residual information.

The program instructions may be further for performing: including, in the first bitstream, an indication that, for at least part of the input data item, the decoded data item is to be determined without using at least one of: the sixth set of layers, or the decoded residual information.

The program instructions may be further for performing: including, in the first bitstream, an indication that, for at least part of the input data item, the decoded data item is to be determined without using at least one of: the third set of layers, or the second set of features.

In accordance with another example embodiment, a (non-transitory) program storage device readable by a machine may be provided, tangibly embodying instructions executable by the machine for performing operations, the operations comprising: determining, with a codec, a first set of features based, at least partially, on an input data item using, at least, a first set of layers; determining a first latent tensor based, at least partially, on the first set of features using, at least, a second set of layers; encoding the first latent tensor in a first bitstream; decoding the encoded first latent tensor from the first bitstream; determining a second set of features based, at least partially, on the decoded first latent tensor using, at least, a third set of layers; determining residual information based, at least partially, on the first set of features and the second set of features; determining a second latent tensor based, at least partially, on the residual information using, at least, a fifth set of layers; encoding the second latent tensor in a second bitstream; decoding the encoded second latent tensor from the second bitstream; determining decoded residual information based, at least partially, on the decoded second latent tensor using, at least, a sixth set of layers; and determining a decoded data item based, at least partially, on the second set of features and the decoded residual information using, at least, a fourth set of layers.

In accordance with another example embodiment, a (non-transitory) computer-readable medium comprising instructions that, when executed by an apparatus, cause the apparatus to perform at least the following: determining, with a codec, a first set of features based, at least partially, on an input data item using, at least, a first set of layers; determining a first latent tensor based, at least partially, on the first set of features using, at least, a second set of layers; encoding the first latent tensor in a first bitstream; decoding the encoded first latent tensor from the first bitstream; determining a second set of features based, at least partially, on the decoded first latent tensor using, at least, a third set of layers; determining residual information based, at least partially, on the first set of features and the second set of features; determining a second latent tensor based, at least partially, on the residual information using, at least, a fifth set of layers; encoding the second latent tensor in a second bitstream; decoding the encoded second latent tensor from the second bitstream; determining decoded residual information based, at least partially, on the decoded second latent tensor using, at least, a sixth set of layers; and determining a decoded data item based, at least partially, on the second set of features and the decoded residual information using, at least, a fourth set of layers.

A computer implemented system comprising: at least one processor and at least one (non-transitory) memory storing instructions that, when executed by the at least one processor, cause the system at least to perform: determining, with a codec, a first set of features based, at least partially, on an input data item using, at least, a first set of layers; determining a first latent tensor based, at least partially, on the first set of features using, at least, a second set of layers; encoding the first latent tensor in a first bitstream; decoding the encoded first latent tensor from the first bitstream; determining a second set of features based, at least partially, on the decoded first latent tensor using, at least, a third set of layers; determining residual information based, at least partially, on the first set of features and the second set of features; determining a second latent tensor based, at least partially, on the residual information using, at least, a fifth set of layers; encoding the second latent tensor in a second bitstream; decoding the encoded second latent tensor from the second bitstream; determining decoded residual information based, at least partially, on the decoded second latent tensor using, at least, a sixth set of layers; and determining a decoded data item based, at least partially, on the second set of features and the decoded residual information using, at least, a fourth set of layers.

A computer implemented system comprising: means for determining, with a codec, a first set of features based, at least partially, on an input data item using, at least, a first set of layers; means for determining a first latent tensor based, at least partially, on the first set of features using, at least, a second set of layers; means for encoding the first latent tensor in a first bitstream; means for decoding the encoded first latent tensor from the first bitstream; means for determining a second set of features based, at least partially, on the decoded first latent tensor using, at least, a third set of layers; means for determining residual information based, at least partially, on the first set of features and the second set of features; means for determining a second latent tensor based, at least partially, on the residual information using, at least, a fifth set of layers; means for encoding the second latent tensor in a second bitstream; means for decoding the encoded second latent tensor from the second bitstream; means for determining decoded residual information based, at least partially, on the decoded second latent tensor using, at least, a sixth set of layers; and means for determining a decoded data item based, at least partially, on the second set of features and the decoded residual information using, at least, a fourth set of layers.

In accordance with one example embodiment, an apparatus may comprise: at least one processor; and at least one memory storing instructions that, when executed by the at least one processor, cause the apparatus at least to: determine a first set of features based, at least partially, on an input data item using, at least, a first set of layers; determine a first latent tensor based, at least partially, on the first set of features using, at least, a second set of layers; encode the first latent tensor in a bitstream; determine residual information based, at least partially, on the first set of features and a second set of features associated with the input data item; determine a second latent tensor based, at least partially, on the residual information using, at least, a third set of layers; and encode the second latent tensor in the bitstream.

The residual information may comprise residual information in a feature domain.

Determining the residual information may comprise the example apparatus being further configured to: determine at least one first signal based, at least partially, on the first set of features and the second set of features; and provide the first at least one signal to the third set of layers.

Determining the residual information may comprise the example apparatus being further configured to: determine a difference between the first set of features and the second set of features.

The difference between the first set of features and the second set of features may comprise an element-wise subtraction between the first set of features and the second set of features.

The residual information may be determined using a fourth set of layers.

Determining the residual information may comprise the example apparatus being further configured to: concatenate the first set of features and the second set of features.

Determining the residual information may comprise the example apparatus being further configured to: provide the first set of features and the second set of features to the sixth set of layers.

The example apparatus may be further configured to: reduce the residual information; and determine the second latent tensor based, at least partially, on the reduced residual information.

Reducing the residual information may comprise the example apparatus being further configured to at least one of: decrease a spatial resolution of the residual information; and/or decrease a number of channels representing the residual information.

The residual information may be determined based, at least partially, on a reduced version of the first set of features and a reduced version of the second set of features.

The input data item may comprise a current picture, and the example apparatus may be further configured to: determine a third set of features based, at least partially, on at least one previous picture using a further set of layers, wherein the first latent tensor may be further determined based on the third set of features.

The current picture may comprise a current picture in one of: an output order of a plurality of pictures, a display order of the plurality of pictures, or a coding order of the plurality of pictures.

The first set of layers and the further set of layers may be, at least, substantially similar.

The first latent tensor may comprise, at least, motion information in a feature domain.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The input data item may comprise at least one of: visual data, an image, a portion of the image, a video frame, a portion of the video frame, or audio information.

The example apparatus may comprise at least one of: an end-to-end learned encoder, an intra-frame encoder, an inter-frame encoder, a video encoder, or an image encoder.

The second set of features may comprise an initial reconstruction of the first set of features of the input data item.

The second latent tensor may be determined further based on the second set of features.

In accordance with one embodiment, an example method may be provided comprising: determining, with an encoder, a first set of features based, at least partially, on an input data item using, at least, a first set of layers; determining a first latent tensor based, at least partially, on the first set of features using, at least, a second set of layers; encoding the first latent tensor in a bitstream; determining residual information based, at least partially, on the first set of features and a second set of features associated with the input data item; determining a second latent tensor based, at least partially, on the residual information using, at least, a third set of layers; and encoding the second latent tensor in the bitstream.

The residual information may comprise residual information in a feature domain.

The determining of the residual information may comprise: determining at least one first signal based, at least partially, on the first set of features and the second set of features; and providing the at least one first signal to the third set of layers.

The determining of the residual information may comprise: determining a difference between the first set of features and the second set of features.

The difference between the first set of features and the second set of features may comprise an element-wise subtraction between the first set of features and the second set of features.

The residual information may be determined using a fourth set of layers.

The determining of the residual information may comprise: concatenating the first set of features and the second set of features.

The determining of the residual information may comprise: providing the first set of features and the second set of features to the sixth set of layers.

The example method may further comprise: reducing the residual information; and determining the second latent tensor based, at least partially, on the reduced residual information.

The reducing of the residual information may comprise at least one of: decreasing a spatial resolution of the residual information; and/or decreasing a number of channels representing the residual information.

The residual information may be determined based, at least partially, on a reduced version of the first set of features and a reduced version of the second set of features.

The input data item may comprise a current picture, and the example method may further comprise: determining a third set of features based, at least partially, on at least one previous picture using a further set of layers, wherein the first latent tensor may be further determined based on the third set of features.

The current picture may comprise a current picture in one of: an output order of a plurality of pictures, a display order of the plurality of pictures, or a coding order of the plurality of pictures.

The first set of layers and the further set of layers may be, at least, substantially similar.

The first latent tensor may comprise, at least, motion information in a feature domain.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The input data item may comprise at least one of: visual data, an image, a portion of the image, a video frame, a portion of the video frame, or audio information.

The encoder may comprise at least one of: an end-to-end learned encoder, an intra-frame encoder, an inter-frame encoder, a video encoder, or an image encoder.

The second set of features may comprise an initial reconstruction of the first set of features of the input data item.

The second latent tensor may be determined further based on the second set of features.

In accordance with one example embodiment, an apparatus may comprise: circuitry configured to perform: determining, with an encoder, a first set of features based, at least partially, on an input data item using, at least, a first set of layers; circuitry configured to perform: determining a first latent tensor based, at least partially, on the first set of features using, at least, a second set of layers; circuitry configured to perform: encoding the first latent tensor in a bitstream; circuitry configured to perform: determining residual information based, at least partially, on the first set of features and a second set of features associated with the input data item; circuitry configured to perform: determining a second latent tensor based, at least partially, on the residual information using, at least, a third set of layers; and circuitry configured to perform: encoding the second latent tensor in the bitstream.

In accordance with one example embodiment, an apparatus may comprise: processing circuitry; memory circuitry including computer program code, the memory circuitry and the computer program code configured to, with the processing circuitry, enable the apparatus to: determine a first set of features based, at least partially, on an input data item using, at least, a first set of layers; determine a first latent tensor based, at least partially, on the first set of features using, at least, a second set of layers; encode the first latent tensor in a bitstream; determine residual information based, at least partially, on the first set of features and a second set of features associated with the input data item; determine a second latent tensor based, at least partially, on the residual information using, at least, a third set of layers; and encode the second latent tensor in the bitstream.

In accordance with one example embodiment, an apparatus may comprise means for: determining a first set of features based, at least partially, on an input data item using, at least, a first set of layers; determining a first latent tensor based, at least partially, on the first set of features using, at least, a second set of layers; encoding the first latent tensor in a bitstream; determining residual information based, at least partially, on the first set of features and a second set of features associated with the input data item; determining a second latent tensor based, at least partially, on the residual information using, at least, a third set of layers; and encoding the second latent tensor in the bitstream.

The residual information may comprise residual information in a feature domain.

The means configured for determining the residual information may comprise means configured for: determining at least one first signal based, at least partially, on the first set of features and the second set of features; and providing the at least one first signal to the third set of layers.

The means configured for determining the residual information may comprise means configured for: determining a difference between the first set of features and the second set of features.

The difference between the first set of features and the second set of features may comprise an element-wise subtraction between the first set of features and the second set of features.

The residual information may be determined using a fourth set of layers.

The means configured for determining the residual information may comprise means configured for: concatenating the first set of features and the second set of features.

The means configured for determining the residual information may comprise means configured for: providing the first set of features and the second set of features to the sixth set of layers.

The means may be further configured for: reducing the residual information; and determining the second latent tensor based, at least partially, on the reduced residual information.

The means configured for reducing the residual information may comprise the means configured for at least one of: decreasing a spatial resolution of the residual information; and/or decreasing a number of channels representing the residual information.

The residual information may be determined based, at least partially, on a reduced version of the first set of features and a reduced version of the second set of features.

The input data item may comprise a current picture, wherein the means may be further configured for: determining a third set of features based, at least partially, on at least one previous picture using a further set of layers, wherein the first latent tensor may be further determined based on the third set of features.

The current picture may comprise a current picture in one of: an output order of a plurality of pictures, a display order of the plurality of pictures, or a coding order of the plurality of pictures.

The first set of layers and the further set of layers may be, at least, substantially similar.

The first latent tensor may comprise, at least, motion information in a feature domain.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The input data item may comprise at least one of: visual data, an image, a portion of the image, a video frame, a portion of the video frame, or audio information.

The example apparatus may comprise at least one of: an end-to-end learned encoder, an intra-frame encoder, an inter-frame encoder, a video encoder, or an image encoder.

The second set of features may comprise an initial reconstruction of the first set of features of the input data item.

The second latent tensor may be determined further based on the second set of features.

In accordance with one example embodiment, a (non-transitory) computer-readable medium comprising instructions stored thereon which, when executed with at least one processor, cause the at least one processor to: determine, with an encoder, a first set of features based, at least partially, on an input data item using, at least, a first set of layers; determine a first latent tensor based, at least partially, on the first set of features using, at least, a second set of layers; encode the first latent tensor in a bitstream; determine residual information based, at least partially, on the first set of features and a second set of features associated with the input data item; determine a second latent tensor based, at least partially, on the residual information using, at least, a third set of layers; and encode the second latent tensor in the bitstream.

In accordance with one example embodiment, a (non-transitory) computer-readable medium comprising program instructions stored thereon for performing at least the following: determining, with an encoder, a first set of features based, at least partially, on an input data item using, at least, a first set of layers; determining a first latent tensor based, at least partially, on the first set of features using, at least, a second set of layers; encoding the first latent tensor in a bitstream; determining residual information based, at least partially, on the first set of features and a second set of features associated with the input data item; determining a second latent tensor based, at least partially, on the residual information using, at least, a third set of layers; and encoding the second latent tensor in the bitstream.

The residual information may comprise residual information in a feature domain.

The program instructions stored thereon for performing determining the residual information may comprise program instructions for performing: determining at least one first signal based, at least partially, on the first set of features and the second set of features; and causing providing of the at least one first signal to the third set of layers.

The program instructions stored thereon for performing determining the residual information may comprise program instructions for performing: determining a difference between the first set of features and the second set of features.

The difference between the first set of features and the second set of features may comprise an element-wise subtraction between the first set of features and the second set of features.

The residual information may be determined using a fourth set of layers.

The program instructions stored thereon for performing determining the residual information may comprise program instructions for performing: concatenating the first set of features and the second set of features.

The program instructions stored thereon for performing determining the residual information may comprise program instructions for performing: providing the first set of features and the second set of features to the sixth set of layers.

The example computer-readable medium may be further configured for performing: reducing the residual information; and determining the second latent tensor based, at least partially, on the reduced residual information.

The program instructions stored thereon for performing reducing the residual information may comprise program instructions for performing at least one of: decreasing a spatial resolution of the residual information; and/or decreasing a number of channels representing the residual information.

The residual information may be determined based, at least partially, on a reduced version of the first set of features and a reduced version of the second set of features.

The input data item may comprise a current picture, and the example computer-readable medium may be further configured for performing: determining a third set of features based, at least partially, on at least one previous picture using a further set of layers, wherein the first latent tensor may be further determined based on the third set of features.

The current picture may comprise a current picture in one of: an output order of a plurality of pictures, a display order of the plurality of pictures, or a coding order of the plurality of pictures.

The first set of layers and the further set of layers may be, at least, substantially similar.

The first latent tensor may comprise, at least, motion information in a feature domain.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The input data item may comprise at least one of: visual data, an image, a portion of the image, a video frame, a portion of the video frame, or audio information.

The encoder may comprise at least one of: an end-to-end learned encoder, an intra-frame encoder, an inter-frame encoder, a video encoder, or an image encoder.

The second set of features may comprise an initial reconstruction of the first set of features of the input data item.

The second latent tensor may be determined further based on the second set of features.

In accordance with another example embodiment, a (non-transitory) program storage device readable by a machine may be provided, tangibly embodying instructions executable by the machine for performing operations, the operations comprising: determining, with an encoder, a first set of features based, at least partially, on an input data item using, at least, a first set of layers; determining a first latent tensor based, at least partially, on the first set of features using, at least, a second set of layers; encoding the first latent tensor in a bitstream; determining residual information based, at least partially, on the first set of features and a second set of features associated with the input data item; determining a second latent tensor based, at least partially, on the residual information using, at least, a third set of layers; and encoding the second latent tensor in the bitstream.

In accordance with another example embodiment, a (non-transitory) computer-readable medium comprising instructions that, when executed by an apparatus, cause the apparatus to perform at least the following: determining, with an encoder, a first set of features based, at least partially, on an input data item using, at least, a first set of layers; determining a first latent tensor based, at least partially, on the first set of features using, at least, a second set of layers; encoding the first latent tensor in a bitstream; determining residual information based, at least partially, on the first set of features and a second set of features associated with the input data item; determining a second latent tensor based, at least partially, on the residual information using, at least, a third set of layers; and encoding the second latent tensor in the bitstream.

A computer implemented system comprising: at least one processor and at least one (non-transitory) memory storing instructions that, when executed by the at least one processor, cause the system at least to perform: determining, with an encoder, a first set of features based, at least partially, on an input data item using, at least, a first set of layers; determining a first latent tensor based, at least partially, on the first set of features using, at least, a second set of layers; encoding the first latent tensor in a bitstream; determining residual information based, at least partially, on the first set of features and a second set of features associated with the input data item; determining a second latent tensor based, at least partially, on the residual information using, at least, a third set of layers; and encoding the second latent tensor in the bitstream.

A signal with embedded data, the signal being encoded in accordance with an encoding process which comprises: determining, with an encoder, a first set of features based, at least partially, on an input data item using, at least, a first set of layers; determining a first latent tensor based, at least partially, on the first set of features using, at least, a second set of layers; encoding the first latent tensor in a bitstream; determining residual information based, at least partially, on the first set of features and a second set of features associated with the input data item; determining a second latent tensor based, at least partially, on the residual information using, at least, a third set of layers; and encoding the second latent tensor in the bitstream.

A computer implemented system comprising: means for determining, with an encoder, a first set of features based, at least partially, on an input data item using, at least, a first set of layers; means for determining a first latent tensor based, at least partially, on the first set of features using, at least, a second set of layers; means for encoding the first latent tensor in a bitstream; means for determining residual information based, at least partially, on the first set of features and a second set of features associated with the input data item; means for determining a second latent tensor based, at least partially, on the residual information using, at least, a third set of layers; and means for encoding the second latent tensor in the bitstream.

In accordance with one example embodiment, an apparatus may comprise: at least one processor; and at least one memory storing instructions that, when executed by the at least one processor, cause the apparatus at least to: decode an encoded first latent tensor, associated with an input data item, from a bitstream; determine a set of features based, at least partially, on the decoded first latent tensor using, at least, a first set of layers; decode an encoded second latent tensor from the bitstream; determine decoded residual information based, at least partially, on the decoded second latent tensor using, at least, a second set of layers; and determine a decoded data item based, at least partially, on the set of features and the decoded residual information using, at least, a third set of layers.

The decoded residual information may comprise decoded residual information in a feature domain.

Determining the decoded data item may comprise the example apparatus being further configured to: determine at least one signal based, at least partially, on the set of features and the decoded residual information; and determine the decoded data item based, at least partially, on the at least one signal using the third set of layers.

Determining the decoded data item may comprise the example apparatus being further configured to: sum the set of features and the decoded residual information; and determine the decoded data item based, at least partially, on the summed set of features and decoded residual information using the third set of layers.

The summed set of features and decoded residual information may comprise an element-wise addition of the set of features and the decoded residual information.

determining the decoded data item may comprise the example apparatus being further configured to: refine the set of features based, at least partially, on the decoded residual information using a fourth set of layers; and determine the decoded data item based, at least partially, on the refined set of features using the third set of layers.

Determining the decoded data item may comprise the example apparatus being further configured to: concatenate the set of features and the decoded residual information; and determine the decoded data item based, at least partially, on the concatenated set of features and decoded residual information using the third set of layers.

Determining the decoded data item may comprise the example apparatus being further configured to: provide the set of features to the second set of layers; and provide an output of the second set of layers to the third set of layers.

Determining the decoded data item may comprise the example apparatus being further configured to: provide the set of features and the decoded residual information to the third set of layers.

The example apparatus may be further configured to: expand at least one signal, wherein the at least one signal may be based, at least partially, on the decoded residual information; and provide the at least one expanded signal to the third set of layers.

Expanding the at least one signal may comprise the example apparatus being further configured to at least one of: increase a spatial resolution of the at least one signal; and/or increase a number of channels representing the at least one signal.

The at least one signal may be further based on the set of features.

The decoded data item may be determined based, at least partially, on a reduced version of the set of features and the decoded residual information.

Determining the decoded data item may comprise the example apparatus being further configured to: expand the decoded residual information; determine at least one signal based, at least partially, on the set of features and the expanded decoded residual information; and determine the decoded data item based, at least partially, on the at least one determined signal using, at least, the third set of layers.

The input data item may comprise a current picture, and the example apparatus may be further configured to: determine a further set of features based, at least partially, on at least one previous picture, wherein the set of features may be further determined based on the further set of features.

The current picture may comprise a current picture in one of: an output order of a plurality of pictures, a display order of the plurality of pictures, or a coding order of the plurality of pictures.

The input data item may comprise at least one of: visual data, an image, a portion of the image, a video frame, a portion of the video frame, or audio information.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The further set of features may comprise at least one signal determined during coding of the at least one previous picture based, at least partially, on: a set of features determined for the at least one previous picture based on a decoded latent tensor associated with the at least one previous picture, and decoded residual information associated with the at least one previous picture.

The example apparatus may comprise at least one of: an end-to-end learned decoder, an intra-frame decoder, an inter-frame decoder, a video decoder, or an image decoder.

The set of features may comprise an initial reconstruction of a first set of features of the input data item.

Determining the decoded data item may comprise the example apparatus being further configured to: for at least part of the input data item, determine at least part of the decoded data item based on at least part of the set of features and not the decoded residual information.

The decoded residual information may be determined further based on the decoded first latent tensor.

In accordance with one embodiment, an example method may be provided comprising: decoding, with a decoder, an encoded first latent tensor, associated with an input data item, from a bitstream; determining a set of features based, at least partially, on the decoded first latent tensor using, at least, a first set of layers; decoding an encoded second latent tensor from the bitstream; determining decoded residual information based, at least partially, on the decoded second latent tensor using, at least, a second set of layers; and determining a decoded data item based, at least partially, on the set of features and the decoded residual information using, at least, a third set of layers.

The decoded residual information may comprise decoded residual information in a feature domain.

The determining of the decoded data item may comprise: determining at least one signal based, at least partially, on the set of features and the decoded residual information; and determining the decoded data item based, at least partially, on the at least one signal using the third set of layers.

The determining of the decoded data item may comprise: summing the set of features and the decoded residual information; and determining the decoded data item based, at least partially, on the summed set of features and decoded residual information using the third set of layers.

The summed set of features and decoded residual information may comprise an element-wise addition of the set of features and the decoded residual information.

The determining of the decoded data item may comprise: refining the set of features based, at least partially, on the decoded residual information using a fourth set of layers; and determining the decoded data item based, at least partially, on the refined set of features using the third set of layers.

The determining of the decoded data item may comprise: concatenating the set of features and the decoded residual information; and determining the decoded data item based, at least partially, on the concatenated set of features and decoded residual information using the third set of layers.

The determining of the decoded data item may comprise: providing the set of features to the second set of layers; and providing an output of the second set of layers to the third set of layers.

The determining of the decoded data item may comprise: providing the set of features and the decoded residual information to the third set of layers.

The example method may further comprise: expanding at least one signal, wherein the at least one signal may be based, at least partially, on the decoded residual information; and providing the at least one expanded signal to the third set of layers.

The expanding of the at least one signal may comprise at least one of: increasing a spatial resolution of the at least one signal; and/or increasing a number of channels representing the at least one signal.

The at least one signal may be further based on the set of features.

The decoded data item may be determined based, at least partially, on a reduced version of the set of features and the decoded residual information.

The determining of the decoded data item may comprise: expanding the decoded residual information; determining at least one signal based, at least partially, on the set of features and the expanded decoded residual information; and determining the decoded data item based, at least partially, on the at least one determined signal using, at least, the third set of layers.

The input data item may comprise a current picture, and the example method may further comprise: determining a further set of features based, at least partially, on at least one previous picture, wherein the set of features may be further determined based on the further set of features.

The current picture may comprise a current picture in one of: an output order of a plurality of pictures, a display order of the plurality of pictures, or a coding order of the plurality of pictures.

The input data item may comprise at least one of: visual data, an image, a portion of the image, a video frame, a portion of the video frame, or audio information.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The further set of features may comprise at least one signal determined during coding of the at least one previous picture based, at least partially, on: a set of features determined for the at least one previous picture based on a decoded latent tensor associated with the at least one previous picture, and decoded residual information associated with the at least one previous picture.

The decoder may comprise at least one of: an end-to-end learned decoder, an intra-frame decoder, an inter-frame decoder, a video decoder, or an image decoder.

The set of features may comprise an initial reconstruction of a first set of features of the input data item.

The determining of the decoded data item may comprise: for at least part of the input data item, determining at least part of the decoded data item based on at least part of the set of features and not the decoded residual information.

The decoded residual information may be determined further based on the decoded first latent tensor.

In accordance with one example embodiment, an apparatus may comprise: circuitry configured to perform: decoding, with a decoder, an encoded first latent tensor, associated with an input data item, from a bitstream; circuitry configured to perform: determining a set of features based, at least partially, on the decoded first latent tensor using, at least, a first set of layers; circuitry configured to perform: decoding an encoded second latent tensor from the bitstream; circuitry configured to perform: determining decoded residual information based, at least partially, on the decoded second latent tensor using, at least, a second set of layers; and circuitry configured to perform: determining a decoded data item based, at least partially, on the set of features and the decoded residual information using, at least, a third set of layers.

In accordance with one example embodiment, an apparatus may comprise: processing circuitry; memory circuitry including computer program code, the memory circuitry and the computer program code configured to, with the processing circuitry, enable the apparatus to: decode an encoded first latent tensor, associated with an input data item, from a bitstream; determine a set of features based, at least partially, on the decoded first latent tensor using, at least, a first set of layers; decode an encoded second latent tensor from the bitstream; determine decoded residual information based, at least partially, on the decoded second latent tensor using, at least, a second set of layers; and determine a decoded data item based, at least partially, on the set of features and the decoded residual information using, at least, a third set of layers.

In accordance with one example embodiment, an apparatus may comprise means for: decoding an encoded first latent tensor, associated with an input data item, from a bitstream; determining a set of features based, at least partially, on the decoded first latent tensor using, at least, a first set of layers; decoding an encoded second latent tensor from the bitstream; determining decoded residual information based, at least partially, on the decoded second latent tensor using, at least, a second set of layers; and determining a decoded data item based, at least partially, on the set of features and the decoded residual information using, at least, a third set of layers.

The decoded residual information may comprise decoded residual information in a feature domain.

The means configured for determining the decoded data item may comprise means configured for: determining at least one signal based, at least partially, on the set of features and the decoded residual information; and determining the decoded data item based, at least partially, on the at least one signal using the third set of layers.

The means configured for determining the decoded data item may comprise means configured for: summing the set of features and the decoded residual information; and determining the decoded data item based, at least partially, on the summed set of features and decoded residual information using the third set of layers.

The summed set of features and decoded residual information may comprise an element-wise addition of the set of features and the decoded residual information.

The means configured for determining the decoded data item may comprise means configured for: refining the set of features based, at least partially, on the decoded residual information using a fourth set of layers; and determining the decoded data item based, at least partially, on the refined set of features using the third set of layers.

The means configured for determining the decoded data item may comprise means configured for: concatenating the set of features and the decoded residual information; and determining the decoded data item based, at least partially, on the concatenated set of features and decoded residual information using the third set of layers.

The means configured for determining the decoded data item may comprise means configured for: providing the set of features to the second set of layers; and providing an output of the second set of layers to the third set of layers.

The means configured for determining the decoded data item may comprise means configured for: providing the set of features and the decoded residual information to the third set of layers.

The means may be further configured for: expanding at least one signal, wherein the at least one signal may be based, at least partially, on the decoded residual information; and providing the at least one expanded signal to the third set of layers.

The means configured for expanding the at least one signal may comprise means configured for at least one of: increasing a spatial resolution of the at least one signal; and/or increasing a number of channels representing the at least one signal.

The at least one signal may be further based on the set of features.

The decoded data item may be determined based, at least partially, on a reduced version of the set of features and the decoded residual information.

The means configured for determining the decoded data item may comprise means configured for: expanding the decoded residual information; determining at least one signal based, at least partially, on the set of features and the expanded decoded residual information; and determining the decoded data item based, at least partially, on the at least one determined signal using, at least, the third set of layers.

The input data item may comprise a current picture, wherein the means may be further configured for: determining a further set of features based, at least partially, on at least one previous picture, wherein the set of features may be further determined based on the further set of features.

The current picture may comprise a current picture in one of: an output order of a plurality of pictures, a display order of the plurality of pictures, or a coding order of the plurality of pictures.

The input data item may comprise at least one of: visual data, an image, a portion of the image, a video frame, a portion of the video frame, or audio information.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The further set of features may comprise at least one signal determined during coding of the at least one previous picture based, at least partially, on: a set of features determined for the at least one previous picture based on a decoded latent tensor associated with the at least one previous picture, and decoded residual information associated with the at least one previous picture.

The example apparatus may comprise at least one of: an end-to-end learned decoder, an intra-frame decoder, an inter-frame decoder, a video decoder, or an image decoder.

The set of features may comprise an initial reconstruction of a first set of features of the input data item.

The means configured for determining the decoded data item may comprise means configured for: for at least part of the input data item, determining at least part of the decoded data item based on at least part of the set of features and not the decoded residual information.

The decoded residual information may be determined further based on the decoded first latent tensor.

In accordance with one example embodiment, a (non-transitory) computer-readable medium comprising instructions stored thereon which, when executed with at least one processor, cause the at least one processor to: decode, with a decoder, an encoded first latent tensor, associated with an input data item, from a bitstream; determine a set of features based, at least partially, on the decoded first latent tensor using, at least, a first set of layers; decode an encoded second latent tensor from the bitstream; determine decoded residual information based, at least partially, on the decoded second latent tensor using, at least, a second set of layers; and determine a decoded data item based, at least partially, on the set of features and the decoded residual information using, at least, a third set of layers.

In accordance with one example embodiment, a (non-transitory) computer-readable medium comprising program instructions stored thereon for performing at least the following: decoding, with decoder, an encoded first latent tensor, associated with an input data item, from a bitstream; determining a set of features based, at least partially, on the decoded first latent tensor using, at least, a first set of layers; decoding an encoded second latent tensor from the bitstream; determining decoded residual information based, at least partially, on the decoded second latent tensor using, at least, a second set of layers; and determining a decoded data item based, at least partially, on the set of features and the decoded residual information using, at least, a third set of layers.

The decoded residual information may comprise decoded residual information in a feature domain.

The program instructions stored thereon for performing determining the decoded data item may comprise program instructions for performing: determining at least one signal based, at least partially, on the set of features and the decoded residual information; and determining the decoded data item based, at least partially, on the at least one signal using the third set of layers.

The program instructions stored thereon for performing determining the decoded data item may comprise program instructions for performing: summing the set of features and the decoded residual information; and determining the decoded data item based, at least partially, on the summed set of features and decoded residual information using the third set of layers.

The summed set of features and decoded residual information may comprise an element-wise addition of the set of features and the decoded residual information.

The program instructions stored thereon for performing determining the decoded data item may comprise program instructions for performing: refining the set of features based, at least partially, on the decoded residual information using a fourth set of layers; and determining the decoded data item based, at least partially, on the refined set of features using the third set of layers.

The program instructions stored thereon for performing determining the decoded data item may comprise program instructions for performing: concatenating the set of features and the decoded residual information; and determining the decoded data item based, at least partially, on the concatenated set of features and decoded residual information using the third set of layers.

The program instructions stored thereon for performing determining the decoded data item may comprise program instructions for performing: causing providing of the set of features to the second set of layers; and causing providing of an output of the second set of layers to the third set of layers.

The program instructions stored thereon for performing determining the decoded data item may comprise program instructions for performing: causing providing of the set of features and the decoded residual information to the third set of layers.

The example computer-readable medium may be further configured for performing: expanding at least one signal, wherein the at least one signal may be based, at least partially, on the decoded residual information; and causing providing of the at least one expanded signal to the third set of layers.

The program instructions stored thereon for performing expanding the at least one signal may comprise program instructions for performing at least one of: increasing a spatial resolution of the at least one signal; and/or increasing a number of channels representing the at least one signal.

The at least one signal may be further based on the set of features.

The decoded data item may be determined based, at least partially, on a reduced version of the set of features and the decoded residual information.

The program instructions stored thereon for performing determining the decoded data item may comprise program instructions stored thereon for performing: expanding the decoded residual information; determining at least one signal based, at least partially, on the set of features and the expanded decoded residual information; and determining the decoded data item based, at least partially, on the at least one determined signal using, at least, the third set of layers.

The input data item may comprise a current picture, and the example computer-readable medium may be further configured for performing: determining a further set of features based, at least partially, on at least one previous picture, wherein the set of features may be further determined based on the further set of features.

The current picture may comprise a current picture in one of: an output order of a plurality of pictures, a display order of the plurality of pictures, or a coding order of the plurality of pictures.

The input data item may comprise at least one of: visual data, an image, a portion of the image, a video frame, a portion of the video frame, or audio information.

The at least one previous picture may comprise at least one of: at least one previously displayed picture, at least one previously coded picture, or at least one previously output picture.

The at least one previous picture may comprise, at least, a first previous picture and a second previous picture, wherein the first previous picture may comprise a picture with an output time before an output time of the current picture, wherein the second previous picture may comprise a picture with an output time after the output time of the current picture.

The further set of features may comprise at least one signal determined during coding of the at least one previous picture based, at least partially, on: a set of features determined for the at least one previous picture based on a decoded latent tensor associated with the at least one previous picture, and decoded residual information associated with the at least one previous picture.

The decoder may comprise at least one of: an end-to-end learned decoder, an intra-frame decoder, an inter-frame decoder, a video decoder, or an image decoder.

The set of features may comprise an initial reconstruction of a first set of features of the input data item.

The program instructions stored thereon for performing determining the decoded data item may comprise program instructions stored thereon for performing: for at least part of the input data item, determining at least part of the decoded data item based on at least part of the set of features and not the decoded residual information.

The decoded residual information may be determined further based on the decoded first latent tensor.

In accordance with another example embodiment, a (non-transitory) program storage device readable by a machine may be provided, tangibly embodying instructions executable by the machine for performing operations, the operations comprising: decoding, with a decoder, an encoded first latent tensor, associated with an input data item, from a bitstream; determining a set of features based, at least partially, on the decoded first latent tensor using, at least, a first set of layers; decoding an encoded second latent tensor from the bitstream; determining decoded residual information based, at least partially, on the decoded second latent tensor using, at least, a second set of layers; and determining a decoded data item based, at least partially, on the set of features and the decoded residual information using, at least, a third set of layers.

In accordance with another example embodiment, a (non-transitory) computer-readable medium comprising instructions that, when executed by an apparatus, cause the apparatus to perform at least the following: decoding, with a decoder, an encoded first latent tensor, associated with an input data item, from a bitstream; determining a set of features based, at least partially, on the decoded first latent tensor using, at least, a first set of layers; decoding an encoded second latent tensor from the bitstream; determining decoded residual information based, at least partially, on the decoded second latent tensor using, at least, a second set of layers; and determining a decoded data item based, at least partially, on the set of features and the decoded residual information using, at least, a third set of layers.

A computer implemented system comprising: at least one processor and at least one (non-transitory) memory storing instructions that, when executed by the at least one processor, cause the system at least to perform: decoding, with a decoder, an encoded first latent tensor, associated with an input data item, from a bitstream; determining a set of features based, at least partially, on the decoded first latent tensor using, at least, a first set of layers; decoding an encoded second latent tensor from the bitstream; determining decoded residual information based, at least partially, on the decoded second latent tensor using, at least, a second set of layers; and determining a decoded data item based, at least partially, on the set of features and the decoded residual information using, at least, a third set of layers.

A computer implemented system comprising: means for decoding, with a decoder, an encoded first latent tensor, associated with an input data item, from a bitstream; means for determining a set of features based, at least partially, on the decoded first latent tensor using, at least, a first set of layers; means for decoding an encoded second latent tensor from the bitstream; means for determining decoded residual information based, at least partially, on the decoded second latent tensor using, at least, a second set of layers; and means for determining a decoded data item based, at least partially, on the set of features and the decoded residual information using, at least, a third set of layers.

In accordance with one example embodiment, an apparatus may comprise: a first learned codec, wherein the first learned codec may comprise a second learned codec and a third learned codec, wherein the first learned codec may comprise a first encoder and a first decoder, wherein the second learned codec may comprise a second encoder and a second decoder, wherein the third learned codec may comprise a third encoder and a third decoder, wherein the first encoder may comprise, at least, the second encoder and the third encoder, wherein the first decoder may comprise, at least, the second decoder and the second decoder, wherein the second encoder may be configured to determine, with a first set of layers, a first set of features of a data item, wherein the second decoder may be configured to determine, with a second set of layers, an initial reconstruction of the first set of features of the data item, wherein the first encoder may be configured to determine residual information based, at least partially, on the first set of features and the initial reconstruction of the first set of features, wherein the third learned codec may be configured to determine, with one or more sets of layers, reconstructed residual information based, at least partially, on the residual information, wherein the first decoder may be configured to process the initial reconstruction of the first set of features of the data item to determine an output decoded data item based, at least partially, on the initial reconstruction of the first set of features and the reconstructed residual information.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

What is claimed is:

1. An apparatus comprising:
at least one processor; and
at least one memory storing instructions that, when executed by the at least one processor, cause the apparatus at least to:
determine a first set of features based, at least partially, on an input data item using, at least, a first set of layers;
determine a first latent tensor based, at least partially, on the first set of features using, at least, a second set of layers;
encode the first latent tensor in a bitstream;
determine residual information based, at least partially, on the first set of features and a second set of features associated with the input data item;
determine a second latent tensor based, at least partially, on the residual information using, at least, a third set of layers; and
encode the second latent tensor in the bitstream.

2. The apparatus of claim 1, wherein determining the residual information comprises the instructions, when executed with the at least one processor, cause the apparatus to:
determine a difference between the first set of features and the second set of features.

3. The apparatus of claim 1, wherein the input data item comprises a current picture, wherein the instructions, when executed with the at least one processor, cause the apparatus to:
determine a third set of features based, at least partially, on at least one previous picture using a further set of layers, wherein the first latent tensor is further determined based on the third set of features.

4. The apparatus of claim 1, wherein the apparatus comprises at least one of:
an end-to-end learned encoder,
an intra-frame encoder,
an inter-frame encoder,
a video encoder, or
an image encoder.

5. A method comprising:
determining a first set of features based, at least partially, on an input data item using, at least, a first set of layers;
determining a first latent tensor based, at least partially, on the first set of features using, at least, a second set of layers;
encoding the first latent tensor in a bitstream;
determining residual information based, at least partially, on the first set of features and a second set of features associated with the input data item;
determining a second latent tensor based, at least partially, on the residual information using, at least, a third set of layers; and
encoding the second latent tensor in the bitstream.

6. An apparatus comprising:
at least one processor; and
at least one memory storing instructions that, when executed by the at least one processor, cause the apparatus at least to:
decode an encoded first latent tensor, associated with an input data item, from a bitstream, to obtain a decoded first latent tensor;
determine a set of features based, at least partially, on the decoded first latent tensor using, at least, a first set of layers;
decode an encoded second latent tensor from the bitstream, to obtain a decoded second latent tensor;
determine decoded residual information based, at least partially, on the decoded second latent tensor using, at least, a second set of layers; and
determine a decoded data item based, at least partially, on the set of features and the decoded residual information using, at least, a third set of layers.

7. The apparatus of claim 6, wherein the decoded residual information comprises decoded residual information in a feature domain.

8. The apparatus of claim 6, wherein determining the decoded data item comprises the instructions, when executed with the at least one processor, cause the apparatus to:
determine at least one signal based, at least partially, on the set of features and the decoded residual information; and
determine the decoded data item based, at least partially, on the at least one signal using the third set of layers.

9. The apparatus of claim 6, wherein determining the decoded data item comprises the instructions, when executed with the at least one processor, cause the apparatus to:
sum the set of features and the decoded residual information, to obtain a summed output; and
determine the decoded data item based, at least partially, on the summed output using the third set of layers.

10. The apparatus of claim 6, wherein determining the decoded data item comprises the instructions, when executed with the at least one processor, cause the apparatus to:
concatenate the set of features and the decoded residual information, to obtain a concatenated set of features and decoded residual information; and
determine the decoded data item based, at least partially, on the concatenated set of features and decoded residual information using the third set of layers.

11. The apparatus of claim 6, wherein the input data item comprises a current picture, wherein the instructions, when executed with the at least one processor, cause the apparatus to:
determine a further set of features based, at least partially, on at least one previous picture, wherein the set of features is further determined based on the further set of features.

12. The apparatus of claim 11, wherein the current picture comprises a current picture in one of:
an output order of a plurality of pictures,
a display order of the plurality of pictures, or
a coding order of the plurality of pictures.

13. The apparatus of claim 11, wherein the at least one previous picture comprises at least one of:
at least one previously displayed picture,
at least one previously coded picture, or
at least one previously output picture.

14. The apparatus of claim 11, wherein the at least one previous picture comprises, at least, a first previous picture and a second previous picture, wherein the first previous picture comprises a picture with an output time before an output time of the current picture, and wherein the second previous picture comprises a picture with an output time after the output time of the current picture.

15. The apparatus of claim 11, wherein the further set of features comprises at least one signal determined during coding of the at least one previous picture based, at least partially, on:
a set of features determined for the at least one previous picture based on a decoded latent tensor associated with the at least one previous picture, and
decoded residual information associated with the at least one previous picture.

16. The apparatus of claim 6, wherein the input data item comprises at least one of:
visual data,
an image,
a portion of the image,
a video frame,
a portion of the video frame, or
audio information.

17. The apparatus of claim 6, wherein the apparatus comprises at least one of:
an end-to-end learned decoder,
an intra-frame decoder,
an inter-frame decoder,
a video decoder, or
an image decoder.

18. The apparatus of claim 6, wherein determining the decoded data item comprises the instructions, when executed with the at least one processor, cause the apparatus to:
for at least part of the input data item, determine at least part of the decoded data item based on at least part of the set of features and not the decoded residual information.

19. The apparatus of claim 6, wherein the decoded residual information is determined further based on the decoded first latent tensor.

20. A method comprising:
decoding an encoded first latent tensor, associated with an input data item, from a bitstream, to obtain a decoded first latent tensor;
determining a set of features based, at least partially, on the decoded first latent tensor using, at least, a first set of layers;
decoding an encoded second latent tensor from the bitstream, to obtain a decoded second latent tensor;
determining decoded residual information based, at least partially, on the decoded second latent tensor using, at least, a second set of layers; and
determining a decoded data based, at least partially, on the set of features and the decoded residual information using, at least, a third set of layers.
